(19) United States
(12) Patent Application Publication
(10) Pub. No.: US 2007/0013959 A1
(43) Pub. Date: Jan. 18, 2007

(54) PRINTING SYSTEM, PRINTING APPARATUS, PRINTING DATA GENERATING APPARATUS AND PROGRAM, CUTTING INDICATING DATA GENERATING APPARATUS AND PROGRAM, PRINTING PROGRAM, AND PRINTING METHOD

(75) Inventor: Shinji Miwa, Suwa (JP)

Correspondence Address: HARNESS, DICKEY & PIERCE, P.L.C., P.O. BOX 828, BLOOMFIELD HILLS, MI, 48303, US

(73) Assignee: SEIKO EPSON CORPORATION, Tokyo (JP)

(21) Appl. No.: 11/456,634

(22) Filed: Jul. 11, 2006

(30) Foreign Application Priority Data
Jul. 12, 2005 (JP) 2005-202847
Apr. 12, 2006 (JP) 2006-109879

(51) Int. Cl. H04N 1/23

(52) U.S. Cl. 358/304; 358/1.12

(57) ABSTRACT

A system includes: a unit printing on a medium; a unit cutting the medium; a unit comparing data of two adjacent images on the medium; a unit selecting, based on the comparison, a first process adjacently printing the two images or a second process printing the two images with a cutting region therebetween; and a unit generating, for each cutting position, cutting indicating data indicating a cutting process of the cutting unit by corresponding a first cutting process to a cutting position corresponding to the first printing process and corresponding a second cutting process to a cutting position corresponding to the second printing process; and a unit generating printing data based on image data and the selection, wherein the printing unit selects the first or second printing process and prints, and the cutting unit selects the first or second cutting process and cuts.

### BACKGROUND

1. Technical Field

The present invention relates to a printing system, a printing apparatus, a printing method of performing printing or continuous paper such as roll paper, automatically cutting, and ejecting paper sheets, and more particularly, to a printing system, a printing apparatus, a printing data generating apparatus and program, a cutting indicating data generating apparatus and program, a printing program, and a border lines.

2. Related Art

Recently, a printer having a cutter built in a case to automatically cut printing paper has been commercially provided. Particularly, since the printer having such a function can alleviate a burden to a user manually cutting continuously printed paper such as roll paper, the printer has been mainly provided as a printer for roll paper printing.

When image-printed paper is cut, a boundary between a region where a desired image is printed and other region is cut once, so that a printing result where only the desired image is printed can be obtained.

However, the cutting is performed with a machine, and there is an error in the cutting position. Therefore, the one-time cutting may not be sufficient according to shapes of the region where the desired image is printed and other regions. For example, in a case where images are printed on the entire paper, that is, a case where the so-called no-border-line printing is performed, the one-time cutting may cause images of other regions to be mixed into the desired image due to the error of the cutting position.

In this case, when the user does not desire the mixing of the other images, an additional cutting method is needed to prevent the mixing of the other images. On the other hand, in some cases, the mixing of the other images may be allowed according to a printing purpose of the user.

Namely, since determination which cut scheme is employed is made by a user, in a printing system using a printer having an automatic cutting function, a function of receiving an indication of the cut scheme from the user is required. On the other hand, if the indication of the cut scheme is needed every time of the printing, a burden is laid on the user. In addition, in some cases, a suitable cut scheme may be performed without waiting for the indication of the user according to printing conditions set by the user.

For the reason, in a printing system disclosed in JP-A-2003-233480, a printer driver receives one of a one-cut scheme, a two-cut scheme, and an automatic selection indicated by the user and stores the indication, and when the one-cut scheme or the two-cut scheme is indicated, the cutting is performed according to the indication. When the automatic selection is indicated, there is proposed a method of automatically selecting an optimal cut scheme with reference to a paper size, whether or not to perform printing without border line, or settings of printing conditions of a feeding apparatus or the like.

However, in the aforementioned printing system in the related art, although there is an advantage of improving convenience of the cut scheme, in order to reduce a waste of paper, there is a need for omitting a task of preparing empty regions between the continuous printing surfaces when the sheets of the output roll paper are printed without the border lines and automatically cut.

In addition, a method of cutting before printing or a method of performing idle-feeding cutting and rewinding should be operated by coordinating printing control and cutting control, so that a printing controller and a cutting controller may need to be independently disposed in some cases.

### SUMMARY

An advantage of some aspects of the invention is to provide a printing system, a printing apparatus, a printing data generating apparatus and program, a cutting indicating data generating apparatus and program, a printing program, and a printing method capable of preventing a waste of paper and independently controlling a printing controller and a cutting controller.

According to a first aspect of the invention, there is provided a printing system comprising: a printing unit printing a plurality of images on a printing medium; a cutting unit cutting the printing medium; an image comparison unit which compares image data corresponding to adjacent two images in units of two images among a plurality of the images which are continuously printed on the printing medium; a printing process selection unit which, based on a comparison result of the image comparison unit, selects any one of a first printing process of printing the two images in an adjacent manner and a second printing process of preparing a cutting region between the two images and printing the two images; a cutting indicating data generation unit which, for each cutting position of the printing medium based on a selection result of the printing process selection unit, generates cutting indicating data of indicating a cutting process procedure of the cutting unit formed by corresponding a first cutting process of cutting the printing medium with one-time cutting operation to a cutting position corresponding to the first printing process and corresponding a second cutting process of cutting the printing medium with two-times cutting operation to a cutting position corresponding to the second printing process; and a printing data generation unit which generates printing data based on image data corresponding to a plurality of the images and the selection result of the printing process selection unit, wherein the printing unit selects any one of the first and second printing processes for the image data corresponding to a plurality of the images based on the printing data and performs the printing process, and wherein the cutting unit selects any one of the first and second cutting processes based on the cutting indicating data and cuts the printing medium.

In the construction, the first cutting process and second cutting process can be suitably selected according to printing contents, and if possible, by using the first cut process, an unnecessarily discarded part of paper generated by the second cutting process can be prevented.

According to a second aspect of the invention, there is provided a printing system comprising: a printing unit printing a plurality of images on a printing medium so as for a plurality of the images to be continuously aligned; a cutting unit setting a boundary between the images on the printing medium where a plurality of the images are printed by the printing unit as a cutting position and performing a first cutting process of cutting the printing medium with a one-time cutting operation or a second cutting process of cutting the printing medium with a two-times cutting operation; an image comparison unit which compares image data corresponding to adjacent two images in units of two images among a plurality of the images which are continuously printed on the printing medium and determines whether or not a visual effect that feature amounts of the two printed images are in a state of satisfying a predetermined condition occurs; a printing process selection unit which, based on a determination result of the image comparison unit, selects a first printing process of printing the two images in an adjacent manner with respect to the two images in which the visual effect is not determined to occur and selects a second printing process of preparing a cutting region between the two images and printing the two images with respect to the two images in which the visual effect is determined to occur; a cutting indicating data generation unit which, for each cutting position of the printing medium based on a selection result of the printing process selection unit, generates cutting indicating data of indicating a cutting process procedure of the cutting unit formed by corresponding the first cutting process to a cutting position corresponding to the first printing process and corresponding the second cutting process to a cutting position corresponding to the second printing process; a printing data generation unit which generates printing data based on image data corresponding to a plurality of the images and the selection result of the printing process selection unit, wherein the printing unit selects any one of the first and second printing processes for the image data corresponding to a plurality of the images based on the printing data and performs the printing process, and wherein the cutting unit selects either one of the first and second cutting processes based on the cutting indicating data and cuts the printing medium.

In this construction, the first cutting process and second cutting process can be suitably selected according to printing contents, and even in the case of printing without border lines, if possible, by using the first cut process, unnecessarily discarded part of paper generated by the second cutting process can be prevented.

According to a third aspect of the invention, in the printing system of the second aspect, the image comparison unit calculates, based on the image data corresponding to the one of the two adjacent images and the image data corresponding to the other of the two adjacent images, a color difference between the two images and determines based on the calculated color difference whether or not the visual effect occurs.

In the construction, the color difference between the printing colors of the one image and the other image of the two images is as the image data corresponding to the two images. By using the first cutting process in the case of mixing which causes no visual problem, the first cutting process and the second cutting process can be suitably selected.

According to a fourth aspect of the invention, in the printing system of the third aspect, the image data are bitmap image data, and the image comparison unit calculates, based on the image data corresponding to the one of the two adjacent images and the image data corresponding to the other of the two adjacent images, a color difference between regions between the two images, counts the number of dots corresponding to the color difference in a case where the color difference exceeds an allowable value of a predetermined color difference, and determines that the visual effect occurs in a case where the count value exceeds a predetermined allowable count value.

In the construction, the number of dots of the color difference between the printing colors of the one image and the other image of the two images is as the image data corresponding to the two images. By using the first cutting process in the case of mixing which causes no visual problem, the first cutting process and the second cutting process can be suitably selected.

Here, the bitmap image data includes, for example, after rasterizing data. Hereinafter, the same is applicable in fifth, tenth, eleventh, sixteenth, seventeenth, twenty second, twenty third, twenty eighth, twenty ninth, thirty fourth, thirty fifth, fortieth, forty first, forty sixth, forty seventh, fifty second, and fifty third aspects.

According to a fifth aspect of the invention, in the printing system of the third aspect, the image data are bitmap image data, and the image comparison unit calculates, based on the image data corresponding to the one of the two adjacent images and the image data corresponding to the other of the two adjacent images, a color difference between regions between the two images, counts the number of dots corresponding to a case where the color difference exceeds an allowable value of a predetermined color difference for predetermined regions of the two images, and determines that the visual effect occurs in a case where the count value of the predetermined region exceeds a predetermined allowable count value.

In the construction, an allowable range is prepared by using the density of the number of dots in a case where the abnormal color is mixed, and the invisible mixing can be neglected, so that the first cutting process can be performed. Namely, the process of preventing the waste of paper can be performed more times.

According to a sixth aspect of the invention, in the printing system of the fourth or fifth aspect, the calculation of the color difference is performed by using at least one of a probability that an error of a cutting position by the cutting unit occurs and a distance between the cutting position by the cutting unit and the dot.

In the construction, an allowable range is prepared by using the number of dots, the dot density, and the probability in a case where the abnormal color is mixed, and the invisible mixing can be neglected, so that the first cutting process can be selected. Namely, the process of preventing the waste of paper can be selected more times.

According to a seventh aspect of the invention, in the printing system of any one of the second to sixth aspects, the printing system further comprises a cutting indicating data printing unit which codes the cutting indicating data and prints the cutting indicating data on the printing medium, wherein the cutting unit reads the printed cutting indicating data and selects any one of the first and second processes based on the read cutting indicating data to cut the printing medium.

In the construction, the printed paper and the electronic data are not needed to be separately treated, and the treatment can be easily made. In addition, there is no need for a separate recording medium to convey the process information.

According to an eighth aspect of the invention, there is provided a printing apparatus having a printing unit printing a plurality of images on a printing medium so as for a plurality of the images to be continuously aligned and a cutting unit setting a boundary between the images on the printing medium where a plurality of the images are printed by the printing unit as a cutting position and performing a first cutting process of cutting the printing medium with a one-time cutting operation or a second cutting process of cutting the printing medium with a two-times cutting operation, the printing apparatus comprising: an image comparison unit which compares image data corresponding to adjacent two images in units of two images among a plurality of the images which are continuously printed on the printing medium and determines whether or not a visual effect that feature amounts of the two printed images are in a state of satisfying a predetermined condition occurs; a printing process selection unit which, based on a determination result of the image comparison unit, selects a first printing process of printing the two images in an adjacent manner with respect to the two images in which the visual effect is not determined to occur and selects a second printing process of preparing a cutting region between the two images and printing the two images with respect to the two images in which the visual effect is determined to occur; a cutting indicating data generation unit which, for each cutting position of the printing medium based on a selection result of the printing process selection unit, generates cutting indicating data of indicating a cutting process procedure of the cutting unit formed by corresponding the first cutting process to a cutting position corresponding to the first printing process and corresponding the second cutting process to a cutting position corresponding to the second printing process; a printing data generation unit which generates printing data based on image data corresponding to a plurality of the images and the selection result of the printing process selection unit, wherein the printing unit selects any one of the first and second printing processes for the image data corresponding to a plurality of the images based on the printing data and performs the printing process, and wherein the cutting unit selects either one of the first and second cutting processes based on the cutting indicating data and cuts the printing medium.

In the construction, an advantage same as that of the second aspect can be obtained.

According to a ninth aspect of the invention, in the printing apparatus of the eighth aspect, the image comparison unit calculates, based on the image data corresponding to the one of the two adjacent images and the image data corresponding to the other of the two adjacent images, a color difference between the two images and determines based on the calculated color difference whether or not the visual effect occurs.

In the construction, an advantage same as that of the third aspect can be obtained.

According to a tenth aspect of the invention, in the printing apparatus of the ninth aspect, the image data are bitmap image data, and the image comparison unit calculates, based on the image data corresponding to the one of the two adjacent images and the image data corresponding to the other of the two adjacent images, a color difference between regions between the two images, counts the number of dots corresponding to the color difference in a case where the color difference exceeds an allowable value of a predetermined color difference, and determines that the visual effect occurs in a case where the count value exceeds a predetermined allowable count value.

In the construction, an advantage same as that of the fourth aspect can be obtained.

According to an eleventh aspect of the invention, in the printing apparatus of the ninth aspect, the image data are bitmap image data, and the image comparison unit calculates, based on the image data corresponding to the one of the two adjacent images and the image data corresponding to the other of the two adjacent images, a color difference between regions between the two images, counts the number of dots corresponding to a case where the color difference exceeds an allowable value of a predetermined color difference for predetermined regions of the two images, and determines that the visual effect occurs in a case where the count value of the predetermined region exceeds a predetermined allowable count value.

In the construction, an advantage same as that of the fifth aspect can be obtained.

According to a twelfth aspect of the invention, in the printing apparatus of the tenth or eleventh aspect, the calculation of the color difference is performed by using at least one of a probability that an error of a cutting position by the cutting unit occurs and a distance between the cutting position by the cutting unit and the dot.

In the construction, an advantage same as that of the sixth aspect can be obtained.

According to a thirteenth aspect of the invention, in the printing apparatus of any one of the eighth to twelfth aspects, the printing apparatus further comprises a cutting indicating data printing unit which codes the cutting indicating data and prints the cutting indicating data on the printing medium, wherein the cutting unit reads the printed cutting indicating data and selects either one of the first and second processes based on the read cutting indicating data to cut the printing medium.

In the construction, an advantage same as that of the seventh aspect can be obtained.

According to a fourteenth aspect of the invention, there is provided a printing apparatus having a printing unit printing a plurality of images on a printing medium so as for a plurality of the images to be continuously aligned, the printing apparatus comprising: an image comparison unit which compares image data corresponding to adjacent two images in units of two images among a plurality of the images which are continuously printed on the printing medium and determines whether or not a visual effect that feature amounts of the two printed images are in a state of satisfying a predetermined condition occurs; a printing process selection unit which, based on a determination result of the image comparison unit, selects a first printing process of printing the two images in an adjacent manner with respect to the two images in which the visual effect is not determined to occur and selects a second printing process of preparing a cutting region between the two images and printing the two images with respect to the two images in which the visual effect is determined to occur; a cutting indicating data generation unit which, for each cutting position of the printing medium based on a selection result of the printing process selection unit, generates cutting indicating data of indicating a cutting process procedure of the cutting unit formed by corresponding a first cutting process of cutting the printing medium with one-time cutting operation to a cutting position corresponding to the first printing process and corresponding a second cutting process of cutting the printing medium with two-times cutting operation to a cutting position corresponding to the second printing process; and a printing data generation unit which generates printing data based on image data corresponding to a plurality of the images and the selection result of the printing process selection unit, wherein the printing unit selects any one of the first and second printing processes for the image data corresponding to a plurality of the images based on the printing data and performs the printing process.

In the construction, an advantage same as that of the second aspect can be obtained.

According to a fifteenth aspect of the invention, in the printing apparatus of the fourteenth aspect, the image comparison unit calculates, based on the image data corresponding to the one of the two adjacent images and the image data corresponding to the other of the two adjacent images, a color difference between the two images and determines based on the calculated color difference whether or not the visual effect occurs.

In the construction, an advantage same as that of the third aspect can be obtained.

According to a sixteenth aspect of the invention, in the printing apparatus of the fifteenth aspect, the image data are bitmap image data, and the image comparison unit calculates, based on the image data corresponding to the one of the two adjacent images and the image data corresponding to the other of the two adjacent images, a color difference between regions between the two images, counts the number of dots corresponding to the color difference in a case where the color difference exceeds an allowable value of a predetermined color difference, and determines that the visual effect occurs in a case where the count value exceeds a predetermined allowable count value.

In the construction, an advantage same as that of the fourth aspect can be obtained.

According to an seventeenth aspect of the invention, in the printing apparatus of the fifteenth aspect, the image data are bitmap image data, and the image comparison unit calculates, based on the image data corresponding to the one of the two adjacent images and the image data corresponding to the other of the two adjacent images, a color difference between regions between the two images, counts the number of dots corresponding to a case where the color difference exceeds an allowable value of a predetermined color difference for predetermined regions of the two images, and determines that the visual effect occurs in a case where the count value of the predetermined region exceeds a predetermined allowable count value.

In the construction, an advantage same as that of the fifth aspect can be obtained.

According to an eighteenth aspect of the invention, in the printing apparatus of the sixteenth or seventeenth aspect, the calculation of the color difference is performed by using at least one of a probability that an error of a cutting position by the cutting unit occurs and a distance between the cutting position by the cutting unit and the dot.

In the construction, an advantage same as that of the sixth aspect can be obtained.

According to a nineteenth aspect of the invention, in the printing apparatus of any one of the fourteenth to eighteenth aspects, the printing apparatus further comprises a cutting indicating data printing unit which codes the cutting indicating data and prints the cutting indicating data on the printing medium, wherein the cutting unit reads the printed cutting indicating data and selects either one of the first and second processes based on the read cutting indicating data to cut the printing medium.

In the construction, an advantage same as that of the seventh aspect can be obtained.

According to a twentieth aspect of the invention, there is provided a printing data generating apparatus comprising: an image comparison unit which, when a plurality of images are printed on a printing medium so as for a plurality of the images to be continuously aligned, compares image data corresponding to adjacent two images in units of two images among a plurality of the images which are continuously printed on the printing medium and determines whether or not a visual effect that feature amounts of the two printed images are in a state of satisfying a predetermined condition occurs; a printing process selection unit which, based on a determination result of the image comparison unit, selects a first printing process of printing the two images in an adjacent manner with respect to the two images in which the visual effect is not determined to occur and selects a second printing process of preparing a cutting region between the two images and printing the two images with respect to the two images in which the visual effect is determined to occur; and a printing data generation unit which generates printing data based on image data corresponding to a plurality of the images and the selection result of the printing process selection unit.

In the construction, an advantage same as that of the second aspect can be obtained.

According to a twenty first aspect of the invention, in the printing data generating apparatus of the twentieth aspect, the image comparison unit calculates, based on the image data corresponding to the one of the two adjacent images and the image data corresponding to the other of the two adjacent images, a color difference between the two images and determines based on the calculated color difference whether or not the visual effect occurs.

In the construction, an advantage same as that of the third aspect can be obtained.

According to a twenty second aspect of the invention, in the printing data generating apparatus of the twenty first aspect, the image data are bitmap image data, and the image comparison unit calculates, based on the image data corresponding to the one of the two adjacent images and the image data corresponding to the other of the two adjacent images, a color difference between regions between the two images, counts the number of dots corresponding to the color difference in a case where the color difference exceeds an allowable value of a predetermined color difference, and determines that the visual effect occurs in a case where the count value exceeds a predetermined allowable count value.

In the construction, an advantage same as that of the fourth aspect can be obtained.

According to a twenty third aspect of the invention, in the printing data generating apparatus of the twenty first aspect, the image data are bitmap image data, and the image comparison unit calculates, based on the image corresponding to the one of the two adjacent images and the image data corresponding to the other of the two adjacent images, a color difference between regions between the two images, counts the number of dots corresponding to a case where the color difference exceeds an allowable value of a predetermined color difference for predetermined regions of the two images, and determines that the visual effect occurs in a case where the count value of the predetermined region exceeds a predetermined allowable count value.

In the construction, an advantage same as that of the fifth aspect can be obtained.

According to a twenty fourth aspect of the invention, in the printing data generating apparatus of the twenty second or twenty third aspect, the calculation of the color difference is performed by using at least one of a probability that an error of a cutting position by the cutting unit occurs and a distance between the cutting position by the cutting unit and the dot.

In the construction, an advantage same as that of the sixth aspect can be obtained.

According to a twenty fifth aspect of the invention, in the printing data generating apparatus of any one of the twentieth to twenty fourth aspects, the printing data generating apparatus further comprises a cutting indicating data printing unit which codes the cutting indicating data and prints the cutting indicating data on the printing medium.

In the construction, an advantage same as that of the seventh aspect can be obtained.

According to a twenty sixth aspect of the invention, there is provided a cutting indicating data generating apparatus having a cutting unit setting a boundary between images on the printing medium where a plurality of the images are printed by a printing unit so as for a plurality of the images to be continuously aligned as a cutting position and performing a first cutting process of cutting the printing medium with a one-time cutting operation or a second cutting process of cutting the printing medium with a two-times cutting operation, the cutting indicating data generating apparatus comprising: an image comparison unit which compares image data corresponding to adjacent two images in units of two images among a plurality of the images which are continuously printed on the printing medium and determines whether or not a visual effect that feature amounts of the two printed images are in a state of satisfying a predetermined condition occurs; a printing process selection unit which, based on a determination result of the image comparison unit, selects a first printing process of printing the two images in an adjacent manner with respect to the two images in which the visual effect is not determined to occur and selects a second printing process of preparing a cutting region between the two images and printing the two images with respect to the two images in which the visual effect is determined to occur; a cutting indicating data generation unit which, for each cutting position of the printing medium based on a selection result of the printing process selection unit, generates cutting indicating data of indicating a cutting process procedure of the cutting unit formed by corresponding the first cutting process to a cutting position corresponding to the first printing process and corresponding the second cutting process to a cutting position corresponding to the second printing process.

In the construction, an advantage same as that of the second aspect can be obtained.

According to a twenty seventh aspect of the invention, in the cutting indicating data generating apparatus of the twenty sixth aspect, the image comparison unit calculates, based on the image data corresponding to the one of the two adjacent images and the image data corresponding to the other of the two adjacent images, a color difference between the two images and determines based on the calculated color difference whether or not the visual effect occurs.

In the construction, an advantage same as that of the third aspect can be obtained.

According to a twenty eighth aspect of the invention, in the cutting indicating data generating apparatus of the twenty seventh aspect, the image data are bitmap image data, and the image comparison unit calculates, based on the image data corresponding to the one of the two adjacent images and the image data corresponding to the other of the two adjacent images, a color difference between regions between the two images, counts the number of dots corresponding to the color difference in a case where the color difference exceeds an allowable value of a predetermined color difference, and determines that the visual effect occurs in a case where the count value exceeds a predetermined allowable count value.

In the construction, an advantage same as that of the fourth aspect can be obtained.

According to an twenty ninth aspect of the invention, in the cutting indicating data generating apparatus of the twenty seventh aspect, the image data are bitmap image data, and the image comparison unit calculates, based on the image data corresponding to the one of the two adjacent images and the image data corresponding to the other of the two adjacent images, a color difference between regions between the two images, counts the number of dots corresponding to a case where the color difference exceeds an allowable value of a predetermined color difference for predetermined regions of the two images, and determines that the visual effect occurs in a case where the count value of the predetermined region exceeds a predetermined allowable count value.

In the construction, an advantage same as that of the fifth aspect can be obtained.

According to a thirtieth aspect of the invention, in the cutting indicating data generating apparatus of the twenty eighth or twenty ninth aspect, the calculation of the color difference is performed by using at least one of a probability that an error of a cutting position by the cutting unit occurs and a distance between the cutting position by the cutting unit and the dot.

In the construction, an advantage same as that of the sixth aspect can be obtained.

According to a thirty first aspect of the invention, in the cutting indicating data generating apparatus of any one of the twenty sixth to thirtieth aspects, the cutting indicating data generating apparatus further comprises a cutting indicating data printing unit which codes the cutting indicating data and prints the cutting indicating data on the printing medium, wherein the cutting unit reads the printed cutting indicating data and selects either one of the first and second processes based on the read cutting indicating data to cut the printing medium.

In the construction, an advantage same as that of the seventh aspect can be obtained.

According to a thirty second aspect of the invention, there is provided a printing program having a process executed by a computer, the process comprising: printing a plurality of images on a printing medium so as for a plurality of the images to be continuously printed; cutting the printing medium by setting a boundary between the images on the printing medium where a plurality of the images are printed as a cutting position and performing a first cutting process of cutting the printing medium with a one-time cutting operation or a second cutting process of cutting the printing medium with a two-times cutting operation, comparing image data corresponding to adjacent two images in units of two images among a plurality of the images which are continuously printed on the printing medium and determining whether or not a visual effect that feature amounts of the two printed images are in a state of satisfying a predetermined condition occurs; selecting a printing process, based on a determination result of the image comparison, to select a first printing process of printing the two images in an adjacent manner with respect to the two images in which the visual effect is not determined to occur and to select a second printing process of preparing a cutting region between the two images and printing the two images with respect to the two images in which the visual effect is determined to occur; for each cutting position of the printing medium based on a selection result of the printing process selection, generating cutting indicating data of indicating a cutting process procedure of the cutting formed by corresponding the first cutting process to a cutting position corresponding to the first printing process and corresponding the second cutting process to a cutting position corresponding to the second printing process; generating printing data based on image data corresponding to a plurality of the images and the selection result of the printing process selection.

In the construction, an advantage same as that of the second aspect can be obtained.

According to a thirty third aspect of the invention, in the printing program of the thirty second aspect, in the image comparison, based on the image data corresponding to the one of the two adjacent images and the image data corresponding to the other of the two adjacent images, a color difference between the two images is calculated, and it is determined based on the calculated color difference whether or not the visual effect occurs.

In the construction, an advantage same as that of the third aspect can be obtained.

According to a thirty fourth aspect of the invention, in the printing program of the thirty third aspect, the image data are bitmap image data, and in the image comparison, based on the image data corresponding to the one of the two adjacent images and the image data corresponding to the other of the two adjacent images, a color difference between regions between the two images is calculated, the number of dots corresponding to the color difference is counted in a case where the color difference exceeds an allowable value of a predetermined color difference, and it is determined that the visual effect occurs in a case where the count value exceeds a predetermined allowable count value.

In the construction, an advantage same as that of the fourth aspect can be obtained.

According to an thirty fifth aspect of the invention, in the printing program of the thirty third aspect, the image data are bitmap image data, and in the image comparison, based on the image data corresponding to the one of the two adjacent images and the image data corresponding to the other of the two adjacent images, a color difference between regions between the two images is calculated, the number of dots is counted corresponding to a case where the color difference exceeds an allowable value of a predetermined color difference for predetermined regions of the two images, and it is determined that the visual effect occurs in a case where the count value of the predetermined region exceeds a predetermined allowable count value.

In the construction, an advantage same as that of the fifth aspect can be obtained.

According to a thirty sixth aspect of the invention, in the printing program of the thirty fourth or thirty fifth aspect, the calculation of the color difference is performed by using at least one of a probability that an error of a cutting position by the cutting occurs and a distance between the cutting position by the cutting and the dot.

In the construction, an advantage same as that of the sixth aspect can be obtained.

According to a thirty seventh aspect of the invention, in the printing program of any one of the thirty second to thirty sixth aspects, the printing program further comprises coding the cutting indicating data and printing the cutting indicating data on the printing medium, wherein the cutting reads the printed cutting indicating data and selects either one of the first and second processes based on the read cutting indicating data to cut the printing medium.

In the construction, an advantage same as that of the seventh aspect can be obtained.

According to a thirty eighth aspect of the invention, there is provided a printing data generating program having a process executed by a computer, the process comprising: when a plurality of images are printed on a printing medium so as for a plurality of the images to be continuously aligned, comparing image data corresponding to adjacent two images in units of two images among a plurality of the images which are continuously printed on the printing medium and determining whether or not a visual effect that feature amounts of the two printed images are in a state of satisfying a predetermined condition occurs; selecting a printing process, based on a determination result of the image comparison, to select a first printing process of printing the two images in an adjacent manner with respect to the two images in which the visual effect is not determined to occur and to select a second printing process of preparing a cutting region between the two images and printing the two images with respect to the two images in which the visual effect is determined to occur; and generating printing data based on image data corresponding to a plurality of the images and the selection result of the printing process selection.

In the construction, an advantage same as that of the second aspect can be obtained.

According to a thirty ninth aspect of the invention, in the printing data generation program of the thirty seventh aspect, in the image comparison, based on the image data corresponding to the one of the two adjacent images and the image data corresponding to the other of the two adjacent images, a color difference between the two images is calculated, and it is determined based on the calculated color difference whether or not the visual effect occurs.

In the construction, an advantage same as that of the third aspect can be obtained.

According to a fortieth aspect of the invention, in the printing data generation program of the thirty ninth aspect, the image data are bitmap image data, and in the image comparison, based on the image data corresponding to the one of the two adjacent images and the image data corresponding to the other of the two adjacent images, a color difference between regions between the two images is calculated, the number of dots corresponding to the color difference is counted in a case where the color difference exceeds an allowable value of a predetermined color difference, and it is determined that the visual effect occurs in a case where the count value exceeds a predetermined allowable count value.

In the construction, an advantage same as that of the fourth aspect can be obtained.

According to an forty first aspect of the invention, in the printing data generation program of the thirty ninth aspect, the image data are bitmap image data, and in the image comparison, based on the image data corresponding to the one of the two adjacent images and the image data corresponding to the other of the two adjacent images, a color difference between regions between the two images is calculated, the number of dots is counted corresponding to a case where the color difference exceeds an allowable value of a predetermined color difference for predetermined regions of the two images, and it is determined that the visual effect occurs in a case where the count value of the predetermined region exceeds a predetermined allowable count value.

In the construction, an advantage same as that of the fifth aspect can be obtained.

According to a forty second aspect of the invention, in the printing data generation program of the fortieth or forty first aspect, the calculation of the color difference is performed by using at least one of a probability that an error of a cutting position by the cutting occurs and a distance between the cutting position by the cutting and the dot.

In the construction, an advantage same as that of the sixth aspect can be obtained.

According to a forty third aspect of the invention, in the printing data generation program of any one of the thirty eighth to forty second aspects, the printing data generation program further comprises coding the cutting indicating data and printing the cutting indicating data on the printing medium.

In the construction, an advantage same as that of the seventh aspect can be obtained.

According to a forty fourth aspect of the invention, there is provided a cutting indicating data generation program having a process executed by a computer, the process having cutting the printing medium by setting a boundary between images on the printing medium where a plurality of the images are printed so as for a plurality of the images to be continuously aligned as a cutting position and performing a first cutting process of cutting the printing medium with a one-time cutting operation or a second cutting process of cutting the printing medium with a two-times cutting operation, the process comprising: comparing image data corresponding to adjacent two images in units of two images among a plurality of the images which are continuously printed on the printing medium and determining whether or not a visual effect that feature amounts of the two printed images are in a state of satisfying a predetermined condition occurs; selecting a printing process, based on a determination result of the image comparison, to select a first printing process of printing the two images in an adjacent manner with respect to the two images in which the visual effect is not determined to occur and to select a second printing process of preparing a cutting region between the two images and printing the two images with respect to the two images in which the visual effect is determined to occur; for each cutting position of the printing medium based on a selection result of the printing process selection, generating cutting indicating data of indicating a cutting process procedure of the cutting formed by corresponding the first cutting process to a cutting position corresponding to the first printing process and corresponding the second cutting process to a cutting position corresponding to the second printing process.

In the construction, an advantage same as that of the second aspect can be obtained.

According to a forty fifth aspect of the invention, in the cutting indicating data generation program of the forty fourth aspect, in the image comparison, based on the image data corresponding to the one of the two adjacent images and the image data corresponding to the other of the two adjacent images, a color difference between the two images is calculated, and it is determined based on the calculated color difference whether or not the visual effect occurs.

In the construction, an advantage same as that of the third aspect can be obtained.

According to a forty sixth aspect of the invention, in the cutting indicating data generation program of the forty fifth aspect, the image data are bitmap image data, and in the image comparison, based on the image data corresponding to the one of the two adjacent images and the image data corresponding to the other of the two adjacent images, a color difference between regions between the two images is calculated, the number of dots corresponding to the color difference is counted in a case where the color difference exceeds an allowable value of a predetermined color difference, and it is determined that the visual effect occurs in a case where the count value exceeds a predetermined allowable count value.

In the construction, an advantage same as that of the fourth aspect can be obtained.

According to an forty seventh aspect of the invention, in the cutting indicating data generation program of the forty fifth aspect, the image data are bitmap image data, and in the image comparison, based on the image data corresponding to the one of the two adjacent images and the image data corresponding to the other of the two adjacent images, a color difference between regions between the two images is calculated, the number of dots is counted corresponding to a case where the color difference exceeds an allowable value of a predetermined color difference for predetermined regions of the two images, and it is determined that the visual effect occurs in a case where the count value of the predetermined region exceeds a predetermined allowable count value.

In the construction, an advantage same as that of the fifth aspect can be obtained.

According to a forty eighth aspect of the invention, in the cutting indicating data generation program of the forty sixth or forty seventh aspect, the calculation of the color difference is performed by using at least one of a probability that an error of a cutting position by the cutting occurs and a distance between the cutting position by the cutting and the dot.

In the construction, an advantage same as that of the sixth aspect can be obtained.

According to a forty ninth aspect of the invention, in the cutting indicating data generation program of any one of the forty fourth to forty eighth aspects, the cutting indicating data generation program further comprises coding the cutting indicating data and printing the cutting indicating data on the printing medium, wherein the cutting reads the printed cutting indicating data and selects either one of the first and second processes based on the read cutting indicating data to cut the printing medium.

In the construction, an advantage same as that of the seventh aspect can be obtained.

According to a fiftieth aspect of the invention, there is provided a printing method having printing a plurality of images on a printing medium so as for a plurality of the images to be continuously printed and cutting the printing medium setting a boundary between the images on the printing medium where a plurality of the images are printed as a cutting position and performing a first cutting process of cutting the printing medium with a one-time cutting operation or a second cutting process of cutting the printing medium with a two-times cutting operation, the printing method comprising: comparing image data corresponding to adjacent two images in units of two images among a plurality of the images which are continuously printed on the printing medium and determining whether or not a visual effect that feature amounts of the two printed images are in a state of satisfying a predetermined condition occurs; selecting a printing process, based on a determination result of the image comparison, to select a first printing process of printing the two images in an adjacent manner with respect to the two images in which the visual effect is not determined to occur and to select a second printing process of preparing a cutting region between the two images and printing the two images with respect to the two images in which the visual effect is determined to occur; for each cutting position of the printing medium based on a selection result of the printing process selection, generating cutting indicating data of indicating a cutting process procedure of the cutting formed by corresponding the first cutting process to a cutting position corresponding to the first printing process and corresponding the second cutting process to a cutting position corresponding to the second printing process; generating printing data based on image data corresponding to a plurality of the images and the selection result of the printing process selection, wherein in the printing, either one of the first and second printing processes for the image data corresponding to a plurality of the images based on the printing data is selected, and the printing process is performed, and wherein in the cutting, either one of the first and second cutting processes based on the cutting indicating data is selected, and the printing medium is cut.

In the construction, an advantage same as that of the second aspect can be obtained.

According to a fifty first aspect of the invention, in the printing method of the fiftieth aspect, in the image comparison, based on the image data corresponding to the one of the two adjacent images and the image data corresponding to the other of the two adjacent images, a color difference between the two images is calculated, and it is determined based on the calculated color difference whether or not the visual effect occurs.

In the construction, an advantage same as that of the third aspect can be obtained.

According to a fifty second aspect of the invention, in the printing method of the fifty first aspect, the image data are bitmap image data, and in the image comparison, based on the image data corresponding to the one of the two adjacent images and the image data corresponding to the other of the two adjacent images, a color difference between regions between the two images is calculated, the number of dots corresponding to the color difference is counted in a case where the color difference exceeds an allowable value of a predetermined color difference, and it is determined that the visual effect occurs in a case where the count value exceeds a predetermined allowable count value.

In the construction, an advantage same as that of the fourth aspect can be obtained.

According to an fifty third aspect of the invention, in the printing method of the fifty first aspect, the image data are bitmap image data, and in the image comparison, based on the image data corresponding to the one of the two adjacent images and the image data corresponding to the other of the two adjacent images, a color difference between regions between the two images is calculated, the number of dots is counted corresponding to a case where the color difference exceeds an allowable value of a predetermined color difference for predetermined regions of the two images, and it is determined that the visual effect occurs in a case where the count value of the predetermined region exceeds a predetermined allowable count value.

In the construction, an advantage same as that of the fifth aspect can be obtained.

According to a fifty fourth aspect of the invention, in the printing method of the fifty second or fifty third aspect, the calculation of the color difference is performed by using at least one of a probability that an error of a cutting position by the cutting occurs and a distance between the cutting position by the cutting and the dot.

In the construction, an advantage same as that of the sixth aspect can be obtained.

According to a fifty fifth aspect of the invention, in the printing method of any one of the fiftieth to fifty fourth aspects, the printing method further comprises coding the cutting indicating data and printing the cutting indicating data on the printing medium, wherein the cutting reads the printed cutting indicating data and selects either one of the first and second processes based on the read cutting indicating data to cut the printing medium.

In the construction, an advantage same as that of the seventh aspect can be obtained.

### BRIEF DESCRIPTION OF THE DRAWINGS

The invention will be described with reference to the accompanying drawings, wherein like numbers reference like elements.

FIG. 1 is a block diagram showing a construction of a printing apparatus according to a first embodiment of the invention.

FIG. 2 is a block diagram showing a hardware construction of the printing apparatus according to the first embodiment of the invention.

FIG. 3 is a side view showing a construction of the printing apparatus according to the first embodiment of the invention.

FIG. 4 is a schematic view for explaining a one-cut scheme.

FIG. 5 is a schematic view for explaining a two-cut scheme.

FIG. 6 is a schematic view showing after-rasterizing dot data.

FIG. 7 is a flowchart showing a one-cut/two-cut determination process.

FIG. 8 is a flowchart showing operations in a case where a density of dots exceeding an allowable value is equal to or more than a predetermined density.

FIG. 9 is a block diagram showing a construction of a printing apparatus according to a second embodiment of the invention.

FIG. 10 is a view showing an example of a job ticket.

FIG. 11 is a block diagram showing a construction of a network system where the invention is employed.

FIG. 12 is a view showing a hardware construction of a host terminal 10a.

FIG. 13 is a flowchart showing a printing job acquisition process.

FIG. 14 is a flowchart showing a printing job scheduling process.

FIGS. 15A and 15B are views showing a result of a continuous printing process on a plurality of images based on a printing job.

FIG. 16 is a block diagram showing a construction of a network system where the invention is employed.

FIG. 17 is a view showing a hardware construction of a host terminal 100b.

FIG. 18 is a flowchart showing a printing job acquisition process.

FIG. 19 is a state of a requested printing job.

FIG. 20 is a view showing a data structure of boundary margin correspondence table 400.

FIG. 21 is a view showing a logic structure of a job schedule tree 420.

FIG. 22 is a flowchart showing a printing job scheduling process.

FIG. 23 is a flowchart showing a printing job scheduling process.

FIG. 24 is a block diagram showing a construction of a network system where the invention is employed.

FIG. 25 is a view showing a data structure of a job ticket.

FIG. 26 is a schematic view showing dot data for adjacent two images.

FIG. 27 is a block diagram showing a construction of a network system where the invention is employed.

### DESCRIPTION OF EXEMPLARY EMBODIMENTS

Hereinafter, a printing system according to embodiments of the invention is described in detail with reference to the accompanying drawings.

### First Embodiment

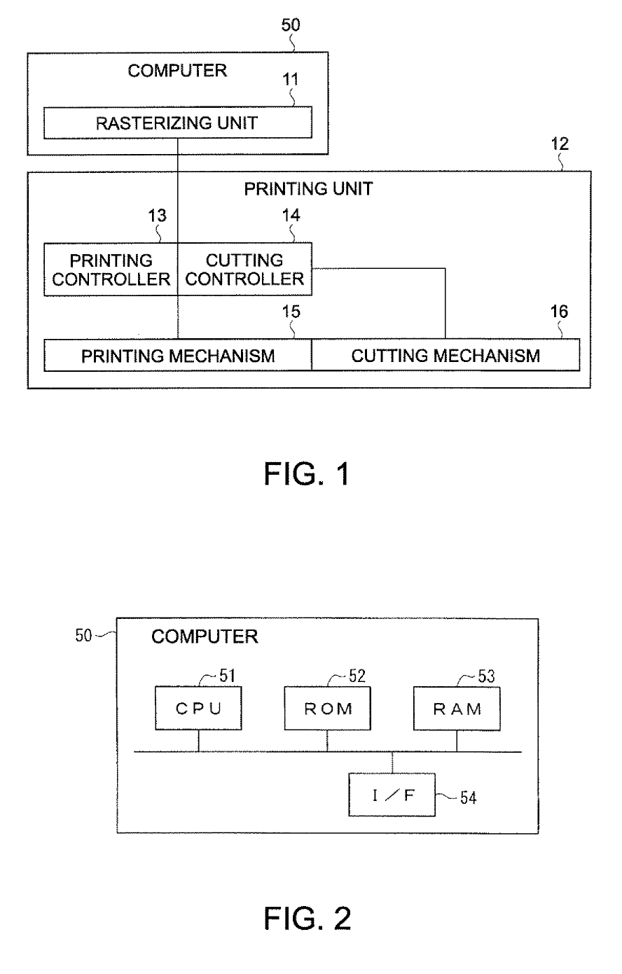

Firstly, a construction of a printing system according to a first embodiment of the invention is described with reference to FIGS. 1 and 2.

FIG. 1 is a block diagram showing the construction of the printing apparatus according to the first embodiment of the invention. FIG. 2 is a block diagram showing an internal hardware construction of a computer.

The computer 50 includes a rasterizing unit 11, and a printing unit 12 includes a printing controller 13, a printing mechanism 15, a cutting controller 14, and a cutting mechanism 16.

The rasterizing unit 11 is a program executed and installed on the computer 50. When a printing command is issued from a user program, printing data is input from the user program to the rasterizing unit 11. The printing data output from the user program is a chunk of image-drawing commands including commands for drawing figures such as lines and arcs or letters, for example, in PostScript, PDF (Portable Document Format), Windows (registered trade mark), or EMF (Enhanced Metafile Format). The rasterizing unit 11 transmits an image to be drawn according to the image-drawing command as dot-alignment data employed in a printing scheme of the printing unit 12. Namely, the rasterizing unit 11 converts vector data to bitmap data and aligns points in a grid manner to represent figures, and the rasterizing unit transmits image data.

In the latter-typing unit 12, the printing controller 13 receives a printing command and rasterized dot data and controls the printing mechanism 15 to perform printing. Similar to the computer 50, the printing controller 13 is constructed with CPU, ROM, RAM, I/F, and the like to execute a program for receiving the printing command and controlling the printing mechanism 15 through the I/F. The cutting controller 14 and the cutting mechanism 16 are integrally constructed in the printing unit 12. In addition, the dot data may be bitmap image data. The dot data is not limited to after-rasterizing data. In this case, the dot data may be input without the rasterizing unit 11.

Similar to the printing controller 13, the cutting controller 14 is constructed with CPU, ROM, RAM, I/F, and the like, and the cutting controller may perform controlling by executing other program routines. The cutting mechanism 16 includes a cutter blade which is driven in a direction perpendicular to a paper conveying direction and operates at a suitable paper conveying position to cut printed paper by a suitable length.

The printing mechanism 15 prints a plurality of images without frame so as to continuously align a plurality of the images on a long printing medium in a longitudinal direction thereof.

The cutting mechanism (cutting unit) 16 sets boundaries of images as cutting positions of the printing medium where a plurality of the images are printed by the printing mechanism 15 and performs a one-cut process of cutting the printing medium with a single cutting operation or a two-cut process of cutting the printing medium with two cutting operations.

As shown in FIG. 2, in an internal hardware construction of the computer, the computer 50 includes a CPU 51, a ROM 52, a RAM 53, I/F (interface) 54, and the like. The computer 50 is constructed with the CPU 51, the RON 52, the RAN 53, the I/F 54, and the like to execute the user program of issuing the printing command.

The computer 50 performs a process for executing an image comparison step of comparing image data corresponding to adjacent two images in units of two images among a plurality of the images which are continuously printed and a printing process selection step of determining based on a comparison result of a image comparison unit whether or not a visual effect that feature amounts of the two printed images are in a state of satisfying a predetermined condition occurs, selecting a first printing process of printing the two images in an adjacent manner with respect to the two images in which the visual effect is not determined to occur, and selecting a second printing process of preparing a cutting region between the two images and printing the two images with respect to the two images in which the visual effect is determined to occur. In addition, for each cutting position of the printing medium based on a selection result of the printing process selection unit, the computer corresponds a one-cut process to a cutting position corresponding to the first printing process, and corresponds a two-cut process to a cutting position corresponding to the second printing process.

In addition, the computer 50 performs a process of executing a cutting indicating data generation step of generating cutting indicating data for indicating a cutting process procedure of the cutting mechanism 16 and a printing data generation step of generating printing data based on the image data corresponding to a plurality of the images and a selection result of the printing process selection unit.

In the construction, the printing mechanism 15 selects either one of the first and second printing processes for the image data corresponding to a plurality of the images based on the printing data and performs the printing process, and the cutting mechanism 16 selects either one of the first and second cutting processes based on the cutting indicating data and cuts the printing medium.

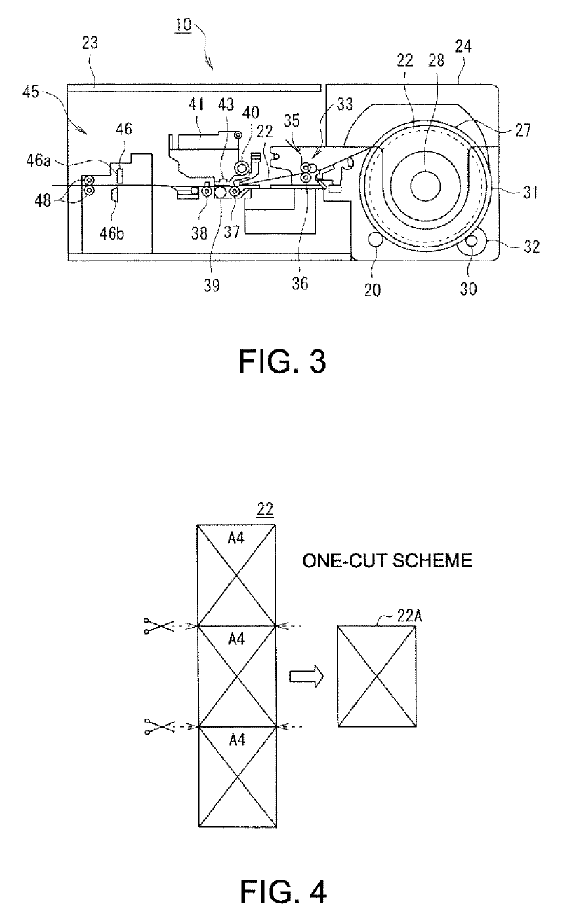

FIG. 3 is a schematic side view showing a construction of a cutting-function-added printing apparatus according to the first embodiment of the invention.

The cutting-function-added printing apparatus 10 includes an apparatus body having the printing mechanism 15 for performing printing on roll paper 22 as printing paper, a paper conveying mechanism for feeding the printing paper, and the cutting mechanism 16 for cutting the printing paper and a roll paper cartridge 24 where the roll paper 22 is set. Besides the roller paper, other printing paper is fed from a paper tray (not shown) or a manual inserting opening.

Roll paper 22 is attached to a drum shaped paper core 27 so that the roll paper 22 can communicably pressed to the axis 28 of the paper core 27. A blade bottom portion 31 of the paper core 27 is disposed to be accommodated in a pair of front and rear roller 29, 30 provided in a bottom portion of the roll paper cassette 24. A roll paper motor 32 for driving the driving roller 30 is disposed at a bottom rear side of the roll paper cassette 24. When the roll paper motor 32 is driven in a positive rotational direction, a rotational force is transmitted from the driving roller 30 to the blade bottom portion 31, so that the roll paper 22 rotates in a direction of inserting (or discharging) the paper. On the other hand, when the roll paper motor 32 is a reserve rotational direction, the rotational force is transmitted from the driving roller 30 to the blade bottom portion 31, so that the roll paper 22 rotates in a direction of winding the paper.

At a front end of the roll paper cassette 24, a feeding unit 33 is disposed at a position corresponding to a conveying path of the roll paper 22 which is fed from the roll paper 22. The feeding unit 33 is constructed with a feeding driven roller 35 and a feeding driving roller 36 to feed the roll paper 22 to the apparatus body 23. The apparatus body 23 is provided with a conveying roller 37 and a discharging roller 38 from an upstream thereof. The components mainly constitute a paper conveying mechanism.

The apparatus body 23 is provided with a carriage shaft 40 thereof so that the carriage 41 is slidably supported by the carriage shaft 40. A read head 43 is attached to a bottom surface of the carriage 41 and droplet of ink are discharged from a nozzle hole (not shown) of the read head 43 thereby a printing onto the roll paper 22 is started. The read head 43 is connected to an ink cartridge (not shown) separated from the apparatus body 23, from which ink is supplied to the read head 43. Between the conveying roller 37 and the discharging roller 38, there is disposed a platen 39 in a paper conveying direction. The components mainly constitute a printing mechanism 15.

In the apparatus body 23, there is provided a cutter unit 45 for cutting the printed roll paper 22. As a machining unit, a cutter 46 is provided to the cutter unit 45. The cutter 46 moves in the width direction of the roll paper (a direction perpendicular to the paper conveying direction) with a driving blade 46a thereof engaged to the fixed blade 46b thereby cutting the roll paper 22. The roll paper 22 cut by the cutter 45 is discharged from the apparatus body 23 by an assist driving roller 48 of the cutting unit 45. The components mainly constitute a cutting mechanism 16.

The printing mechanism 15 is controlled by the CPU 51 which executes the printing command among the printing data transmitted from the computer 50. More specifically, the computer 50 transmits the printing data including the image-drawing command to the printing apparatus 10, so that an arbitrary image can be printed at an arbitrary position.

In addition, the paper conveying mechanism and the cutting mechanism 16 are controlled by the CPU 51 which executes the roll paper conveying command and the cutting command among the printing data transmitted from the computer 50. More specifically, the computer 50 transmits the printing data including the roll paper conveying command and the cutting command to the printing apparatus 10, so that the printing apparatus 10 is allowed to perform paper-conveying by an arbitrary amount of the roll paper, and cutting can be performed at an arbitrary position.

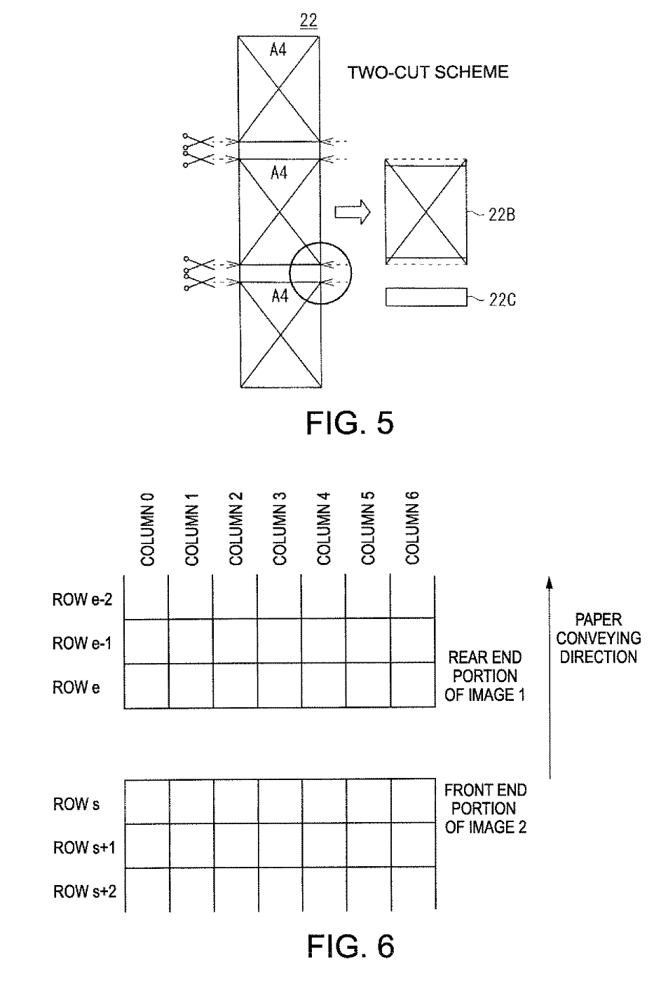

Next, a one-cut scheme and a two-cut scheme is described with reference to FIGS. 4 and 5.

FIGS. 4 and 5 are schematic views showing the one-cut scheme and the two-cut scheme, respectively.

Firstly, the one-cut scheme is described with reference to FIG. 4. In the one-cut scheme, images having a predetermined size (in the embodiment, A4 size) are continuously printed on the roll paper, and the cutting is performed in one time at a boundary line between the images. By the one-cut scheme, a predetermined size of a printing result 22A is obtained. In general, the cutting toll 16 has an error of, for example, about 0.3 mm. For the reason, when the images are continuously printed without a margin, some portions of last and next screens may be mixed into upper and lower ends of the printing result 22A according to the one-cut scheme.

Next, the two-cut scheme is described with reference to FIG. 5. In the two-cut scheme, the images having a A4 size are continuously printed on the roll paper 22 with a margin prepared between the images, and the cutting is performed in two times at up and down portions of a position from a small image of the boundary line between the image and the margin. The position from a small image of the boundary line between the image and the margin is set to be larger than a G difference of the cutting mechanism 16, so that the margin can be negligibly mixed into the image. In the two-cut scheme, a printing result 22B which is shorter than the A4 size in a vertical direction is obtained, and a debris piece 22c is generated.

In general, when a printing paper is automatically with a cutter built in a case and printed, for example, in a case where images are printed on the entire paper, that is, a case where the so-called no-border-line printing is performed, another image is continuously printed, and one-time cutting is performed at a boundary therebetween in a one-cut scheme. However, in this case, due to an error of the cutting position, an image of another region may be mixed into a desired image.

Therefore, in this case, an empty region is provided between the first and second printing regions, and a position which is mixed into the printing region by a distance where the cutting position may be deviated due to the error is set as a cutting position and cut in a two-cut scheme. However, in the two-cut scheme, the empty region between the images are discarded.

In the printing system according to the invention, even in the case of no-border-line printing, contents of boundary regions of the continuously printed images are compared. When the visual difference caused from the deviation of the cutting position is negligible, the one-cut scheme is employed, so that a waste of paper can be prevented.

FIG. 6 is a view for explaining alone-cut/two-cut determination process in the printing system according to the first embodiment of the invention.

As shown in an arrow of the figure, an image 1 and an image 2 following the image 1 are conveyed in a paper conveying direction, and a margin region is interposed between a rear end portion of the image 1 and a front end portion of the image 2. In addition, after-rasterizing dot data of continuously printed images are schematically shown. In the figure, squares denote dots, and rows and columns denote alignment of the dots. Here, positions of the dots are denoted by (row, column). For example, a dot positioned at row e and column 0 is denoted by (e, 0). In the figure, the arrow denotes the paper conveying direction. If a printing head is a printing head for printing line by line, the printing head performs printing in the sequence of row e−2, row e−1, row e, row s, row s+1, and row s+2. In addition, colors of the dots are denoted by c(row, column).

In the example, the cutting position is between the row e and the row s. When the cutting position and the position of the cutting mechanism 16 are aligned with each other by the paper conveying, the cutting controller 14 allows the cutting mechanism 16 to operate to cut the paper. However, due to a mechanical error, there is an error of the cutting position, and an error range is denoted by I. The error range I is predetermined according to a design tolerance of the mechanism or a pervious test. Here, the dimension of the error range I is defined as a “dot (dot number in the paper conveying direction)”. In addition, the separate error ranges I may be allocated to the front direction (a case where there is a deviation in the rear end direction of the image 1) and the rear direction (a case where there is a deviation in the front end direction of the image 2) For example, the front and rear direction error ranges may be defined as l₁ and l₂.

In addition, when the cutting position is deviated, an allowable value (color difference) of a difference between a color of a dot of an image end portion and a color of a dot of another image is denoted by th_{c}. Namely, even though the colors are not accurately equal to each other, a color difference in the case of occurrence of the image mixing does not cause an unpleasant feeling, the mixing is set to be allowable, and the allowable error is predetermined.

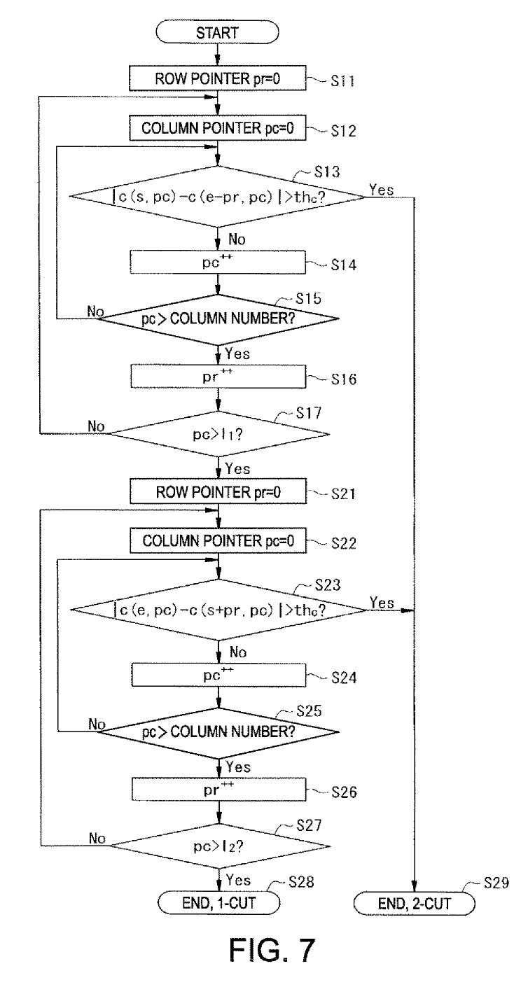

Next, a flow of the one-cut/two-cut determination process is described with respect to FIG. 7.

FIG. 7 is a flowchart showing the one-cut/two-cut determination process operation in the printing apparatus according to the invention.

Firstly, in Step S11, a row pointer is set to pr=0, and in Step S12, a column pointer is set to pc=0. Next, in Step S13, it is determined whether or not an inequality |c(s, pc)−c(e−pr, pc)|>th_{c} is satisfied. When the inequality is not satisfied, in Step S14, pc++ is set. In this case, in Step S15, it is determined whether or not an inequality pc>(column number) is satisfied. When the inequality is satisfied, in Step S16, pr++ is set. In Step S15, when the inequality is not satisfied, the process returns to Step S13, and the same operation is performed. Next, when pr++ is set in Step S16, in Step S17, it is determined whether or not an inequality pc>>l₁ is satisfied. When the inequality is satisfied, in Step S21, the row pointer is set to pr=0, and in Step S22, the column pointer is set to pc=0. Next, in Step S23, it is determined an inequality |c(e, pc)−c(s+pr, pc)|>th_{c} is satisfied. When the inequality is satisfied, Step S29 ends, and two-cut is selected. When the inequality is not satisfied, in Step S24, pc++ is set. In this case, in Step S25, it is determined whether or not the inequality pc>(column number) is satisfied. In Step S25, when the inequality is not satisfied, the process returns to Step S13, and the same operation is performed. Next, when pr++ is set in Step S26, in Step S2, it is determined whether or not an inequality pc>l₂ is satisfied. When the inequality is not satisfied, the process returns to Step S22, and it is determined whether or not the inequality |c(e, pc)−c(s+pr, pc)|>th_{c} is satisfied.

In this manner, in only the paper conveying direction where the cutting position error may occur, the colors between the dot of the image end portion and the dot of the facing image which may be mixed are compared, and when the color difference exceeds an allowable difference, the two-cut is selected.

In addition, in the flowchart, when the color difference of the dot which may be mixed exceeds the allowable value at any one position, the two-cut is selected. However, the following modifications may be considered.

For example, the number of dots of the dots where the color difference exceeds the allowable value is counted, and when the number of dots exceeds a predetermined value, the two-cut may be selected. Alternatively, when a density of dots where the color difference exceeds the allowable value is equal to or more than a predetermined density, the two-cut may be selected (a abnormal color of one dot is invisible, but a group of the abnormal colors is visible).

In addition, in the calculation of the color difference, a magnitude of a probability that the cutting position error occurs may be multiplied. Namely, as a position is departed from an ideal cutting position, the probability of the mixing lowers. The probability value is defined according to the distance from the cutting position, and a weight factor may be allocated to the calculation of the color difference.

In this manner, an allowable range is prepared by using the number of dots, the dot density, and the probability in a case where the abnormal color is mixed, and the invisible mixing can be neglected, so that the one-cut can be performed. Namely, the process of preventing the waste of paper can be performed more times.

In a case where the dot data are R, C, and B or C, M, Y, and K, in the calculation of the color difference, a sum of the difference of the values corresponding to the compared dot data may be required. More specifically, the color difference may be obtained by calculating color values in an absolute color space such as CIE Lab color specification system based on B, G, and B or C, N, Y, and K of the dot data and converting the color values to ΔE value or other values corresponding to visual differences.

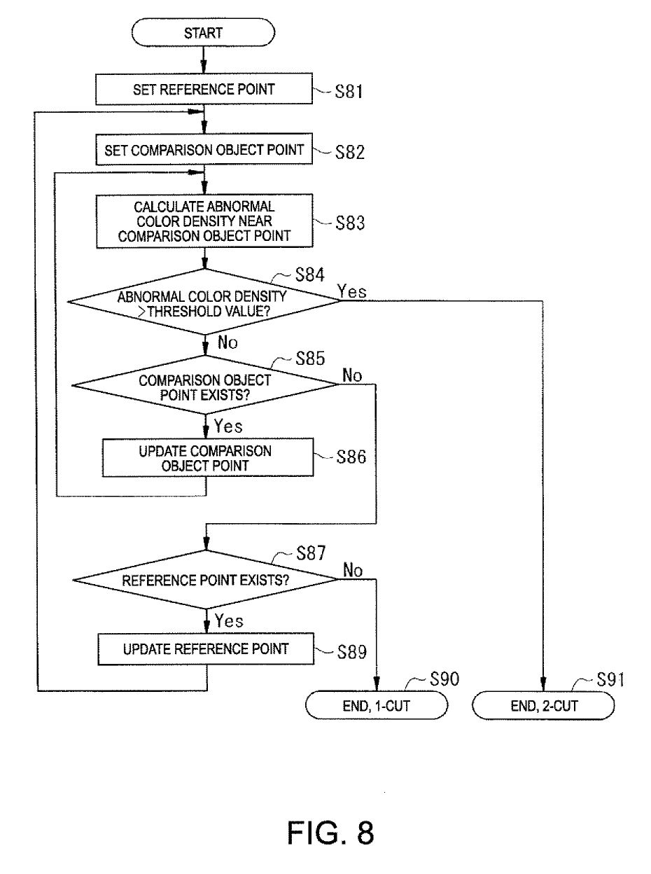

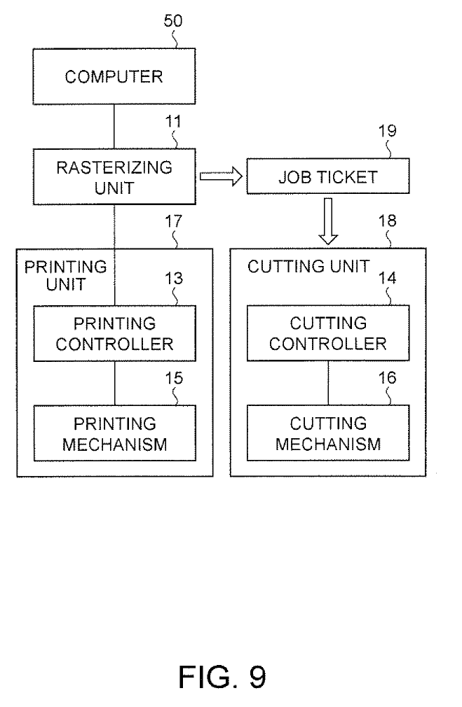

FIG. 8 is a flowchart showing operations for selecting two-cut in the modification where a density of the dots where the color difference exceeds the allowable value is equal to or more than a predetermined density among the aforementioned various modifications.

Firstly, in Step S81, a reference point having a predetermined density is set. Next, in Step S82, a comparison object point is set. Next in Step S83, an abnormal color density near the comparison object point is calculated, and in Step S84, it is determined whether or not “(abnormal color density)>(threshold value)” is satisfied. When (abnormal color density)>(threshold value) is satisfied, in Step S91, the two-cut is selected, and the process ends. When (abnormal color density)>(threshold value) is not satisfied, in Step S85, it is determined whether or not a comparison object point exists. When the comparison object point exists, in Step S86, the comparison object point is updated. And the process returns to Step S83, and the same operations are performed. In Step S85, when a comparison object point does not exist, in Step S87, it is determined whether or not a reference point exists. When the reference point does exist, in Step S89, the reference point is updated. And the process returns to Step S83, and the same operations are performed. In Step S87, when the reference point does not exist, in Step S90, the one-cut is selected, and the process ends.

In addition, the calculation of the abnormal color density is performed by sequentially comparing the dots near the comparison object point with the reference point and counting the number of dots where the color difference exceeds a predetermined threshold value.

Here, advantages of the present invention obtained by the rasterizing unit 11 performing the one-cut/two-cut determination are described.

In general, although the colors of the image data are represented with values of R, G, and B or C, M, Y, and K, colors reproduced with the same value are different among printing apparatuses. For the reason, an output device profile including printing data formed by adding characteristics of the printing apparatus to the values of the input colors is used. In general, since the process is performed before the rasterizing unit 11, the color which intends to be originally represented cannot be determined from the dot data input to the printing controller 13 (if inverting conversion is performed by using the output device profile).

In addition, in general, since calculation performance of the CPU of the printing controller 13 is lower than that of the CPU of the rasterizing unit 11 (in the embodiment, a computer executing a user program), a complicated process such as repeating dot comparison is not suitable.

On the other hand, since a printing apparatus used for output is not yet specified before the rasterizing unit 11, that is, in the user program, any process for printing cannot be determined, and an accurate determination for the dot alignment which is actually printed cannot be performed based on the image data according to the image-drawing command.

Therefore, in the rasterizing unit 11, the input image data is converted to the dot data, and the dot color values are compared in a stage before conversion to the color values suitable to the printing apparatus, so that the most efficient and accurate determination can be obtained.

### Second Embodiment

In the embodiment, a cutting unit is not included in a printing unit, and the invention a implemented by using an independent cutting unit. The embodiment is suitable for a case where the printing is performed by a company, and the cutting is performed by another professional binding company.

FIG. 9 is a block diagram showing a construction of a printing system according to the second embodiment of the invention.

Similar to the first embodiment, the user program is executed by the computer 50.

Similar to the first embodiment, the rasterizing unit 11 may be a program executed by the computer 50 or be constructed by hardware other than the computer 50.

The operations of the rasterizing unit 11, the printing unit 17, and the cutting unit 18 are the same as those of the first embodiment. In the embodiment, since the cutting unit 18 is independently provided, the one-cut/two-cut determination is performed by the rasterizing unit 11, and the printing unit 12 prints the dot data based on the determination result. At the same time, the one-cut/two-cut determination is performed, and the determination result is transmitted to the cutting unit 18.

If the cutting unit 18 is disposed to be close to the rasterizing unit 11 and controlled directly by the rasterizing unit 11, the second embodiment is the same as the first embodiment. However, if not, the information which is to be transmitted to the cutting unit 18 may be transmitted as a job ticket 19. The job ticket 19 is process information which is information required for performing the cutting process and described in a predetermined format.

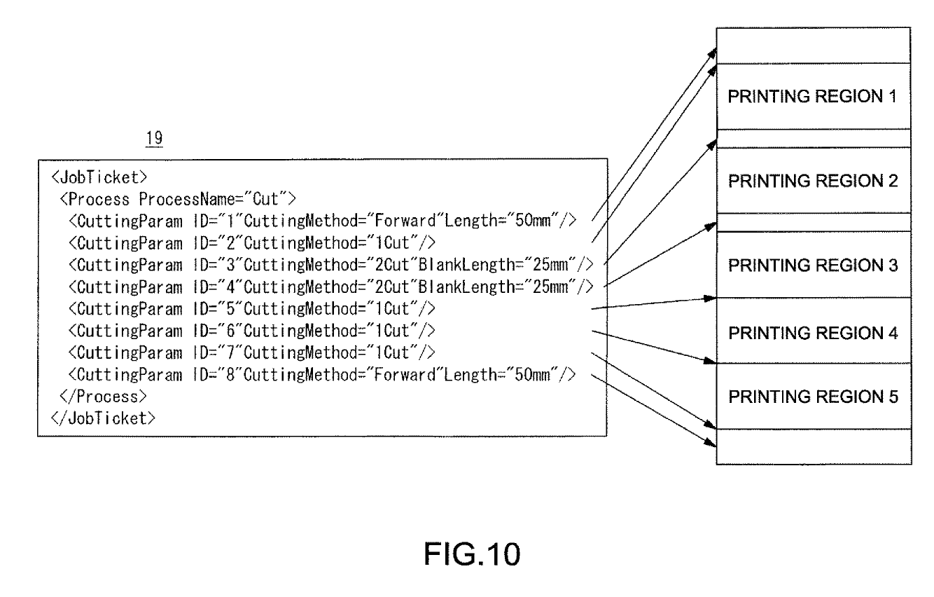

FIG. 10 is a view showing an example of the job ticket.

As shown in the figure, the job ticket is the process information which is information (parameter) required fro performing processes (in this case, the cutting process) in printing regions 1 to 5 and described in a predetermined format. In the example, as Process ProcessName=“Cut”, for each of “CuttingParam”, “CuttingMethod” is represented by “1-Cut” or “2-Cut”. By using the job ticket 19, the job ticket 19 is generated and preserved according to the rasterizing/printing process, and when a separate cutting process is performed, a proper process can be performed by referring to the job ticket 19. In addition, the transmission of the job ticket 19 can be implemented through a network. Alternatively, the job ticket may be transmitted via media such as magnetic recording medium such as FD and MO and barcodes, so that the information can be transmitted to a cutting unit which is not connected to the network.

If the job ticket is in a formats which can be recognized by the cutting controller 14 of the cutting mechanism 16, the rasterizing unit 11 generates the job ticket according to the format. In addition, the job ticket of the printing apparatus is standardized by CIP4 (International Cooperation for the Integration of Processes in prepress, Press and Postpress). By using a job ticket 19 in a format of JDF (Job Definition on Format), although the cutting controller 14 cannot recognize a format of the job ticket in advance, a separate cutting process can be performed by a cutting unit corresponding to the JDF format.

In addition, in a case where the printing is performed in a roll-to-roll manner (the printing is performed on the supplied roll and the printed paper is rolled again) and, after that, the cutting is performed, since the cutting is performed from the rear stage of the time of the printing, the job ticket 19 the cut information generated sequentially according to the rasterizing/printing process may include a process of reversing the sequence thereof after the printing. In this case, the job ticket 19 generated according to the rasterizing/printing process may be coded in a printable format (for example, barcodes) on the paper and printed on a rear end portion of the paper, and the cutting unit 18 is provided with a function of reading the code. As a result, the printed paper and the job ticket 19 are not needed to be separately treated. In addition, since the printed paper and the job ticket can be easily treated, and since there is no need for a separate recording medium to convey the job ticket 19, the efficiency of resources can be improved.

In addition the process of reversing the sequence of the cut information of the job ticket 19 may be performed before the printing of the job ticket 19 or after the reading of the cutting unit 18.

As described above, in the construction of the invention, the printing contents of the boundary of the continuous printing surfaces are compared, and if there is no influence of the mixing of the printing contents caused from the error in the cutting position, the printing is performed in the one-cut manner. By doing so, the one-cut and the two-cut can be selected according to the printing contents, and even in a case where the printing 1 performed without border lines, if possible, the one-cut is selected, so that the unnecessarily discarded part of paper generated by the two-cut scheme can be prevented.

In addition, the comparison of the printing contents is performed based on the color difference between both printing colors. By doing so, the visually negligible mixing can be treated by the one-cut, and the one-cut/two-cut can be properly selected.

In addition, the printing system includes the rasterizing unit 11 and the printing unit 12, and the determination of the cutting method is performed by the rasterizing unit 11. By doing so, in the rasterizing unit 11, the input image data can be converted into the dot data, and in a stage before the data is converted into colors suitable for the printing apparatus, the color value of the dots are preferably compared, so that the accurate determination can be obtained.

In addition, the printing system includes a cutting unit, and the cutting unit is controlled according to the determination of the cut scheme by the rasterizing unit. By doing so, the determination of the cut scheme in the rasterizing unit 11 can be efficiently used for the cutting.

In addition, the rasterizing unit 11 includes a job ticket output unit and prints and outputs the determination result of the cut scheme on the job ticket 19. In addition, the printing system includes a cut apparatus having a job ticket input unit, and the cut apparatus performs cut operations according to the job ticket 19. In the related art, in a case where the printing process and the cutting process are separately performed, the information on the one-cut and two-cut cannot be transmitted to the cutting unit, all the two-cut schemes are used. However, even in a case where the printing process and the cutting process are separately performed, the one-cut and two-cut scheme can be selectively used, so that unnecessarily discard of paper can be reduced.

In addition, in a roll-to-roll printing, the job ticket 19 including the cut information sequentially generated together with the rasterizing/printing process includes a process of inverting the sequence after the completion of the printing. By doing so, the invention can be employed in a cutting unit having no function of changing the sequence of the job ticket 19.

In addition, the job ticket 19 is coded and printed on the printed paper, and then, transmitted. By doing so, the printed paper and the job ticket 19 are not needed to be separately treated, and the treatment can be easily made. In addition, there is no need for a separate recording medium to convey the job ticket 19. As a result, the efficiency of resources can be improved.

### Third Embodiment

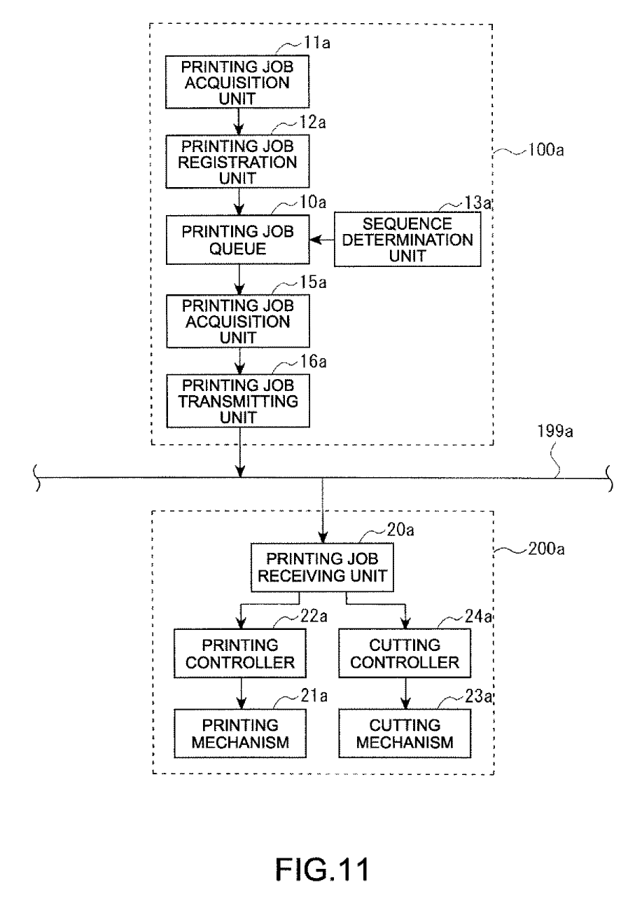

Next, a third embodiment of the invention is described with reference the accompanying drawings. FIGS. 11 to 15 are views showing an image continuous printing system, an image continuous printing program, and image continuous printing method according to the third embodiment of the invention.

Firstly, a construction of a network system where the invention is employed is described.

FIG. 11 is a block diagram showing a construction of the network system where the invention is employed.

As shown in FIG. 11, in a network 199a, a host terminal 100a which is used for a use and a printing apparatus 200a which continuously prints a plurality of images on a roll paper according to a printing request from the host terminal 100a are connected.

The host terminal 100a includes a printing job queue 10a which stores a printing job, a printing job acquisition unit 11a which acquires the printing job, and a printing job registration unit 12a which registers the printing job acquired by the printing job acquisition unit 11a in the printing job queue 10a.

The printing job includes image data constituting the image and margin setting information representing whether or not to set a margin at a boundary between adjacent images. In the margin setting information, either one of a two-cut scheme where the margin is set to the boundary between the adjacent images and a one-cut scheme where the margin is not set to the boundary between the adjacent images is allocated. In the two-cut scheme, a margin is set to the boundary, and for one boundary, the cutting is performed at two positions corresponding to a boundary to the adjacent image and a boundary of the current image, so that the scheme is called two-cut scheme. On the contrary, in the one-cut scheme, a margin is not set to the boundary, and for one boundary, the cutting is performed at the boundary between the adjacent image and the current image, so that the scheme is called one-cut scheme. Which one of the one-cut scheme and the two-cut scheme is to be performed can be determined according to a technique disclosed in JP-A-2003-233480 Alternatively, a process where the user determines the scheme may be employed.

The host terminal 100a includes a sequence determination unit 13a which changes registration sequence of the printing job in the printing job queue 10a, based on the margin setting information included in the printing job, so as for the images where the margin is not set to the boundary or the images where the margin is set to the boundary to be adjacent to each other, a printing job acquisition unit 15a which acquires the printing job from the front end portion of the printing job queue 10a, and a printing job transmitting unit 16a which transmits the printing job acquired by the printing job acquisition unit 15a to the printing apparatus 200a.

The printing apparatus 200a includes a printing job receiving unit 20a which receives the printing job, a printing mechanism 21a which has tools required for the printing on the roll paper, and a printing controller 22a which controls the printing mechanism 21a based on the printing job received by the printing job receiving unit 20a, a cutting mechanism 23a which has tools required for cutting the roll paper, and a cutting controller 24a which controls the cutting mechanism 23a based on the printing job received by the printing job receiving unit 20a.

The printing mechanism 21a includes a printing head which performing printing on the roll paper, a paper ejecting unit which ejects the roll paper, a guide rail which is disposed in a direction perpendicular to the roll paper ejecting direction and movably supports the printing head, and a head driving unit which moves the printing head along the guide rail.

The cutting mechanism 23a includes a cutting head which cuts the roll paper, a guide rail which is disposed in the direction perpendicular to the roll paper ejecting direction and movably supports the cutting head, and a head driving unit which moves the cutting head along the guide rail.

Next, a construction of the host terminal 100a is described in detail.

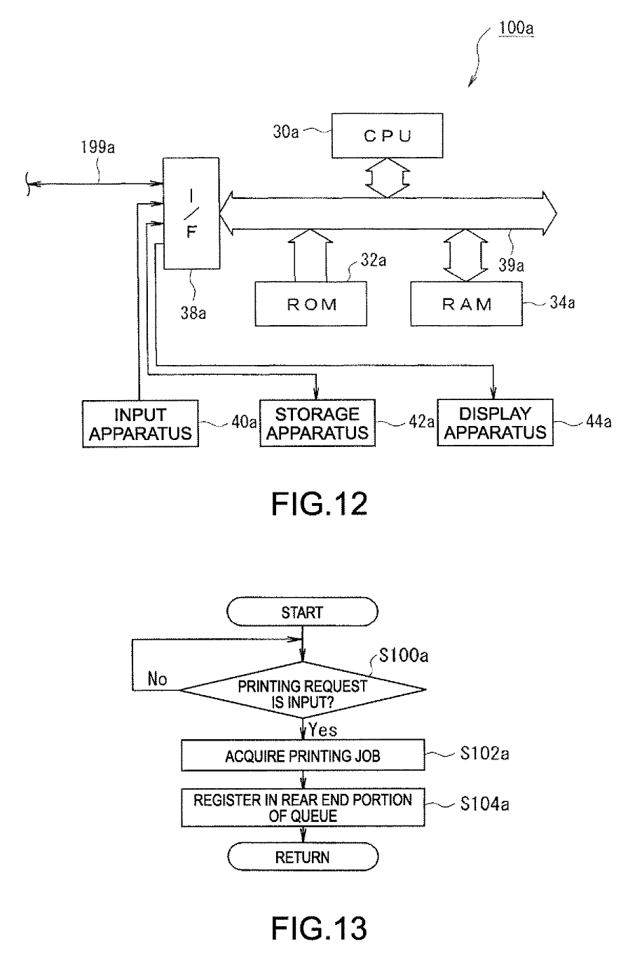

FIG. 12 is a view showing a hardware construction of a host terminal 100a.

As show in FIG. 12, the host terminal 100a includes a CPU 30a which performs calculation and controls the whole system according to a control program, a ROM 32a which stores the control program or the like of the CPU 30a in a predetermined region in advance, a RAM 34a which stores data read from the ROM 32a or the like or calculation results required for calculation operations of the CPU 30a, and an I/F 38a which interfaces data input/output with an external apparatus. These components are connected to each other so as to transmit and receive the data therebetween via a bus 39a which is a signal line for transmitting the data.

The I/F 38a is connected through signal lines to external apparatuses such as an input apparatus 40a which includes a keyboard or a mouse as a human interface for inputting the data, a storage apparatus 42a which stores the data, tables, or the like as files, and a display apparatus 44a which displays a screen according to an image signal and a network 199a.

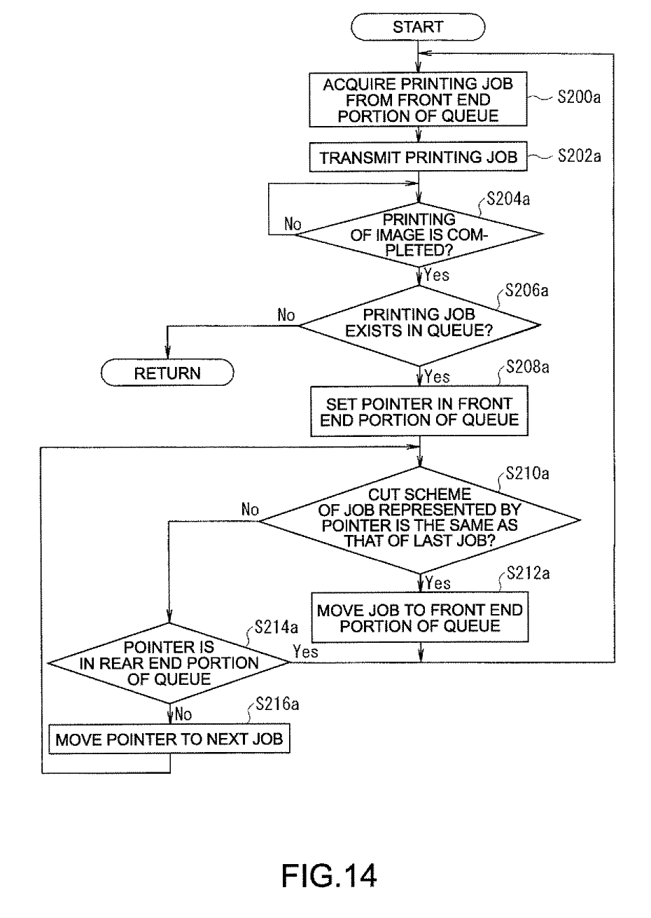

The CPU 30a is constructed with a micro-processing unit or the like and executes predetermined programs stored in a predetermined region of the ROM 32a to perform a printing job acquisition process and a printing job scheduling process shown in the flowcharts of FIGS. 13 and 14 in a time division manner according to the programs.

Firstly, the printing job acquisition process is described.

FIG. 13 is a flowchart showing the printing job acquisition process.

As shown in FIG. 13, when executed in the CPU 30a, the printing job acquisition process firstly proceeds to Step S100a.

In Step S100a, it is determined whether or not a printing request is input from an image editing application or the like. If the printing request is determined to be input (Yes), the process proceeds to Step S102a. If not (No) standby is maintained in Step 100a until the printing request is received.

In Step S102a, a printing job is acquired from the image editing application or the like, and the process proceeds to Step S104a to register the acquired printing job in a rear end portion of the printing job queue 10a. And a series of processes end, and the process returns to an initial process.

Next, the printing job scheduling process is described.

FIG. 14 is a flowchart showing the printing job scheduling process.

As shown in FIG. 14, when executed in the CPU 30a, the printing job scheduling process firstly proceeds to Step S200a.

In Step S200a, the printing job is acquired from the front end portion of the printing job queue 10a, and the process proceeds to Step S202a to transmit the acquired printing job to the printing apparatus 200a. And the process proceeds to Step S204a.

In Step S204a, it is determined whether or not printing of one sheet of image is completed according to communication to the printing apparatus 200a. If the printing of the one sheet of image is determined to be completed (Yes), the process proceeds to Step S206a. If not (No), standby is maintained in Step 204a until the printing of the one sheet of image is completed.

In Step S206a, it is determined whether or not a printing job exists in the printing job queue 10a. If the printing job is determined to exist (Yes), the process proceeds to Step S208a to set a pointer to the front end portion of the printing job queue 10a. And the process proceeds to Step S210a.

In Step S210a, it is determined whether or not the cut scheme of the printing job represented by a pointer is the same as that of the last printing-completed printing job (hereinafter, simply referred to as a last printing job). If the cut scheme is determined to be the same as that of the last printing job (Yes), the process proceeds to Step S212a to move the printing job to the front end of the printing job queue 10a. And the process proceeds to Step S200a.

In Step S210a, if the cut scheme of the printing job represented by the pointer is not determined to be the same as that of the last printing job (No), the process proceeds to Step S214a to determine whether or not the pointer is the rear end portion of the printing job queue 10a. If the pointer is not determined to be the rear end portion of the printing job queue 10a (No), the process proceeds to Step S216a to move the pointer to the next printing job. And the process proceeds to Step S210a.

In Step S214a, if the pointer is determined to be the rear end portion of the printing job queue 10a (Yes), the process proceeds to Step S200a.

In Step S206a, if the printing job is not determined to exist in the printing job queue 10a (No), a series of processes end, and the process returns to the initial process.

Next, operations of the embodiment are described.

In the host terminal 100a, when the printing request is input, in Steps S102a and S104a, the printing job is acquired, and the acquired printing job is registered in the rear end portion of the printing job queue 10a.

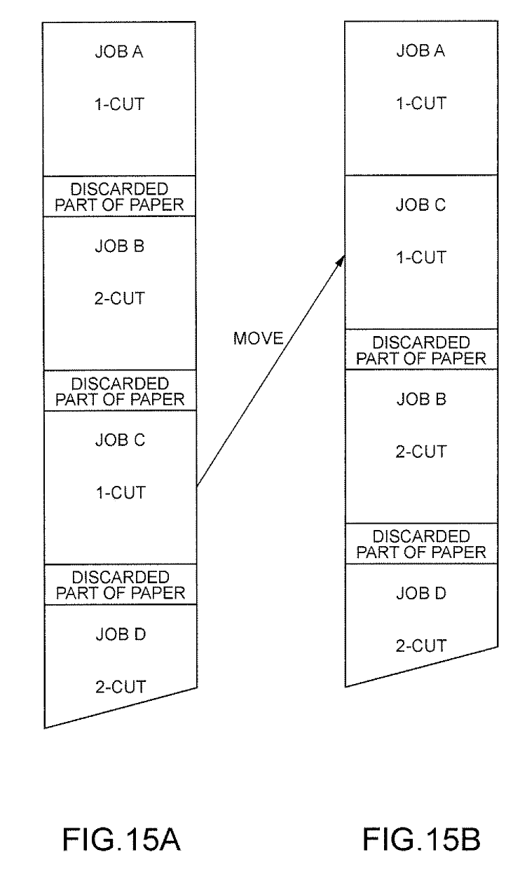

FIG. 15 is a view showing a result of a continuous printing process on a plurality of the images based on the printing job.

As shown in FIG. 15A, as a result of the registration of the printing job, four printing jobs of a one-cut scheme printing job A, a two-cut scheme printing job B, a one-cut scheme printing job C, and a two-cut scheme printing job D are registered in the printing job queue 10a in the sequence thereof. Here, although the printing job A is the one-cut scheme, the printing job B at the rear end thereof is the two-cut scheme, so that discarded paper (lost paper) is generated at the boundary between the images of the printing jobs A and B. Similarly, although the printing job C is the one-cut scheme, the printing job B at the front end thereof and the printing job D at the rear end thereof are two-cut scheme, so that discarded papers are generated at the boundary between the images of the printing jobs B and C and the boundary between the images of the printing jobs C and B. Therefore, if the images are printed in this sequence, three sheets of discarded paper are generated.

In the host terminal 100a, when the printing job is registered, in Steps S200a and S202a, the printing job A is acquired from the front end portion of the printing job queue 10a, and the acquired printing job A is transmitted to the printing apparatus 200a.

In the printing apparatus 200a, when the printing job A is received, the printing controller 22a controls the printing mechanism 21a based on the printing job A. In addition, the cutting controller 24a controls the cutting mechanism 23a based on the printing job A. As a result, the image of the printing job A is printed on the roll paper, and the rear end portion of the image of the printing job A is cut.

In the host terminal 10a, when the printing of the image of the printing job A is completed, in Steps S208a to S216a, the scanning is sequentially performed from the front end portion of the printing job queue 10a to search the printing job of which cut scheme is the same as that of the printing job A. Here, since the printing job C is the one-cut scheme, the printing job C is moved to the front end portion of the printing job queue 10a. Next, the printing job C is acquired from the front end portion of the printing job queue 10a, and the acquired printing job C is transmitted to the printing apparatus 200a.

Since both of the printing jobs B and D are two-cut scheme, the printing is performed in this sequence without exchange thereof.

As shown in FIG. 15B, as a result of the printing of the printing jobs A to D, the discarded paper is not generated at the boundary between the images of the printing jobs A and C, so that the discarded paper is reduced down to two sheet in comparison with the case of the printing in the sequence of FIG. 15A.

By doing so, in the embodiment, the printing job including the image data constituting the image and margin setting information representing whether or not to set the margin at the boundary between the adjacent image is acquired, the acquired printing job is registered in the rear end portion of the printing job queue 10a, the registration sequence of the printing job in the printing job queue 10a is changed based on the margin setting information included in the printing job so as for the images where the margin is not set to the boundary or the images where the margin is set to the boundary to be adjacent to each other, the printing job is acquired from the front end portion of the printing job queue 10a, and the acquired printing job is transmitted to the printing apparatus 200a.

Therefore, in a case where the image having a margin and the image having no margin are mixed and continuously printed, a probability that the images are adjacent to each other is lowered, so that a margin is not generated at the boundary of the image having no margin, and discarded part of paper can be reduced. In addition, the printing control can be performed independently of the cutting control, so that a size of the printing apparatus 200a can be reduced.

In addition, in the embodiment, the printing jobs are sequentially selected from the front end portion of the printing job queue 10a, it is determined whether or not the cut scheme of the selected printing job is the same as that of the last printing job, and if the cut scheme is determined to the same, the selected printing job is moved to the front end portion of the printing job queue 10a.

As a result, the sequence of the images having no margin or the images having a margin cannot be exchanged, so that it is possible to reduce confusion for a user or a burden to an exchanging task after the printing.

### Fourth Embodiment

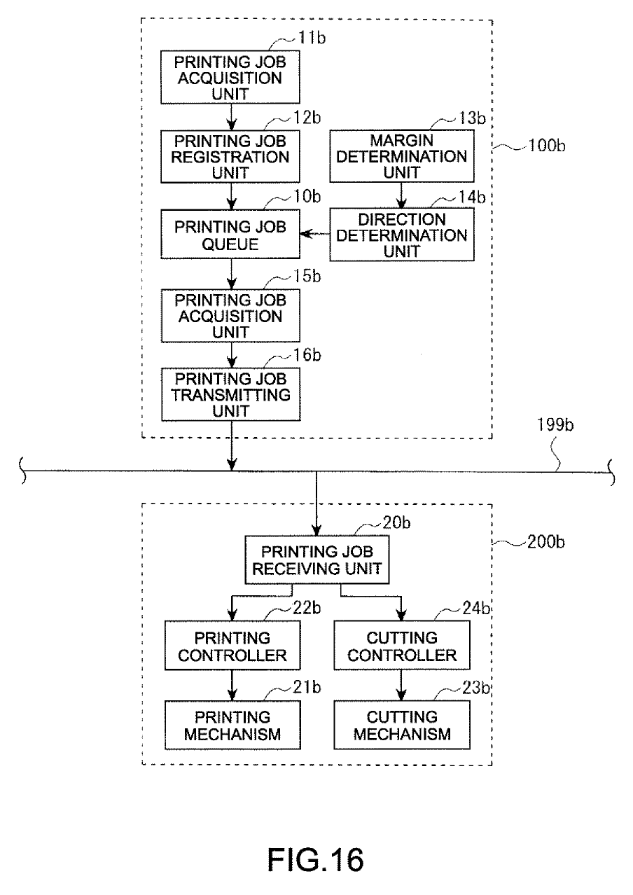

Next, a fourth embodiment of the invention is described with reference to the accompanying drawings. FIGS. 16 to 22 are views showing an image continuous printing system, an image continuous printing program, and an image continuous printing method according to the fourth embodiment.

Firstly, a construction of a network system where the invention is employed is described.

FIG. 16 is a block diagram showing a construction of the network system where the invention is employed.

As shown in FIG. 16, in a network 199b, a host terminal 100b which is used for a use and a printing apparatus 200b which continuously prints a plurality of images on a roll paper according to a printing request from the host terminal 100b are connected.

The host terminal 100b includes a printing job queue 10b which stores a printing job, a printing job acquisition unit 11b which acquires the printing job, and a printing job registration unit 12b which registers the printing job acquired by the printing job acquisition unit 11b in the printing job queue 10b.

The printing job includes image data constituting the image and margin setting information representing whether or not to set margins at two boundaries between adjacent images. In the margin setting information, either one of a two-cut scheme where the margin is set to the boundary between the adjacent images and a one-cut scheme where the margin is not set to the boundary between the adjacent images is allocated. In the two-cut scheme, a margin is set to the boundary, and for one boundary, the cutting is performed at two positions corresponding to a boundary to the adjacent image and a boundary of the current image, so that the scheme is called two-cut scheme. On the contrary, in the one-cut scheme, a margin is not set to the boundary, and for one boundary, the cutting is performed at the boundary between the adjacent image and the current image, so that the scheme is called one-cut scheme. Which one of the one-cut scheme and the two-cut scheme is to be performed can be determined according to a technique disclosed in JP-A-2003-233480. Alternatively, a process where the user determines the scheme may be employed.

The host terminal 100b includes a margin determination unit 13b which compares each boundary of the boundaries of a plurality of the images with each boundary of other images and determine whether or not to set margins to the boundaries and a direction determination unit 14b which changes the registration sequence of the printing 14b in the printing job queue 10b and the direction (hereinafter, simply referred to as a direction) of the images in the adjacent direction, based on a result of the determination of the margin determination unit 13b, so as for the images where the margin is not set to the boundary to be adjacent to each other to share the boundary.

The direction determination unit 14b determines a combination having the largest number of the images where the margin is not set to the boundary and which are adjacent to each other to share the boundary among combinations of the registration sequence of the printing job and the direction of the images, moves the printing job of the to-be-printed image next to the last printed image among the printing jobs to the front end portion of the printing job queue 10b based on the determined sequence and direction, and inverts the direction of the next to-be-printed image.

In addition, the host terminal 100b includes a printing job acquisition unit 15b which acquires the printing job from the front end portion of the printing job queue 10b and a printing job transmitting unit 16b which transmits the printing job acquired by the printing job acquisition unit 11b to the printing apparatus 200b.

The printing apparatus 200b includes a printing job receiving unit 20b which receives the printing job, a printing mechanism 21b which has tools required for the printing on the roll paper, and a printing controller 22b which controls the printing mechanism 21b based on the printing job received by the printing job receiving unit 20b, a cutting mechanism 23b which has tools required for cutting the roll paper, and a cutting controller 24b which controls the cutting mechanism 23b based on the printing job received by the printing job receiving unit 20b.

The printing mechanism 21b includes a printing head which performing printing on the roll paper, a paper ejecting unit which ejects the roil paper, a guide rail which is disposed in a direction perpendicular to the roll paper ejecting direction and movably supports the printing head, and a head driving unit which moves the printing head along the guide rail.

The cutting mechanism 23b Includes a cutting head which cuts the roll paper, a guide rail which is disposed in the direction perpendicular to the roll paper ejecting direction and movably supports the cutting head, and a head driving unit which moves the cutting head along the guide rail.

Next, a construction of the host terminal 100b is described in detail.

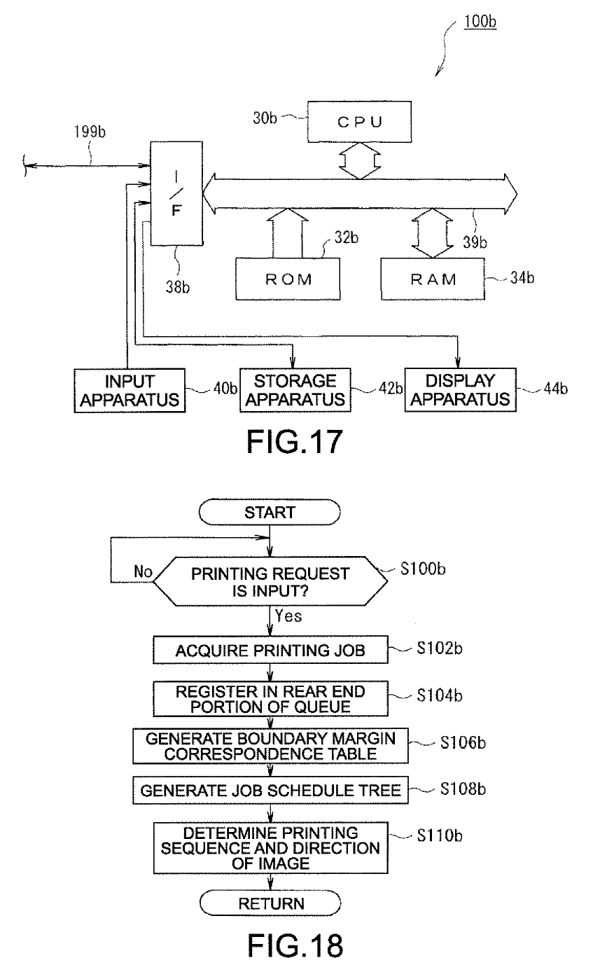

FIG. 17 is a view showing a hardware construction of a host terminal 100b.

As show in FIG. 17, the host terminal 100b includes a CPU 30b which performs calculation and controls the whole system according to a control program, a ROM 32b which stores the control program or the like of the CPU 30b in a predetermined region in advance, a RAY 34b which stores data read from the ROM 32b or the like or calculation results required for calculation operations of the CPU 30b, and an I/F 38b which interfaces data input/output with an external apparatus. These components are connected to each other so as to transmit and receive the data therebetween via a bus 39b which is a signal line for transmitting the data.

The I/F 38b is connected through signal lines to external apparatuses such as an input apparatus 40b which includes a keyboard or a mouse as a human interface for inputting the data, a storage apparatus 42b which stores the data, tables, or the like as files, and a display apparatus 44b which displays a screen according to an image signal and a network 199b.

The CPU 30b is constructed with a micro-processing unit or the like and executes predetermined programs stored in a predetermined region of the ROM 32b to perform a printing job acquisition process and a printing job scheduling process shown in the flowcharts of FIGS. 18 and 22 in a time division manner according to the programs.

Firstly, the printing job acquisition process is described.

FIG. 18 is a flowchart showing the printing job acquisition process.

As shown in FIG. 18, when executed in the CPU 30b, the printing job acquisition process firstly proceeds to Step S100b.

In Step S100b, it is determined whether or not a printing request is input from an image editing application or the like. If the printing request is determined to be input (Yes), the process proceeds to Step S102b. If not (No), standby is maintained in Step 100b until the printing request is received.

In Step S102b, a printing job is acquired from the image editing application or the like, and the process proceeds to Step S104b to register the acquired printing job in a rear end portion of the printing job queue 10b. The process returns to Step 106b.

In Step S106b, each boundary of the boundaries of a plurality of the images is compared with each boundary of other images, it is determined whether or not to set the margins to the boundaries, and a boundary margin correspondence table where presence or absence of the margins for the boundaries is registered is generated. In the determination whether or not the margins are set to the boundaries of the images (namely, whether the one-cut scheme or the two-cut scheme is performed), if the margin is not set in the margin setting information of the two adjacent images with the boundary interposed therebetween, the margin is not determined to be set. If the margin is set in the margin setting information of at least one of the adjacent images, the margin is determined to be set.

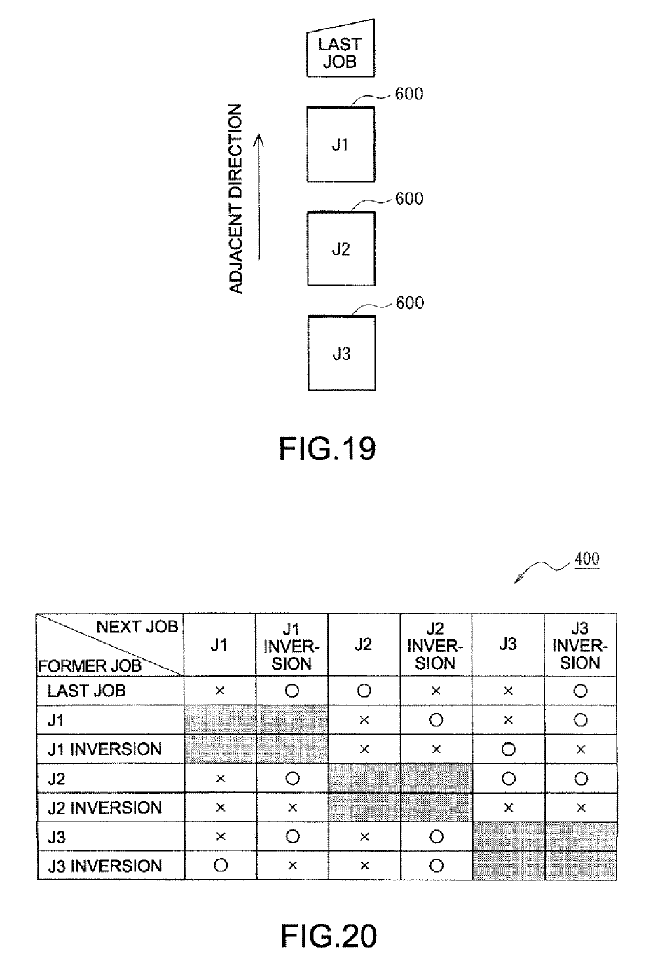

FIG. 19 is a view showing a state of the requested printing job.

As shown in FIG. 19, after the printing is performed according to the last printing job, the printing jobs J1, J2, and J3 are requested in the sequence thereof. The images of the printing jobs can set a direction. With respect to the direction of the images, in a case where the adjacent direction of the images is the up and down direction in the figure as shown in FIG. 19, there are a direction (hereinafter, referred to as a forward direction) where a predetermined edge 600 of the image is directed upward and a direction (hereinafter, referred to as a backward direction) where the predetermined edge 600 is directed downward. In the example of FIG. 19, all the images of the printing jobs J1 to J3 are in the forward direction.

FIG. 20 is a view showing a data structure of a boundary margin correspondence table 400.

As shown in FIG. 20, in the boundary margin correspondence table 400, last printing-completed printing jobs (hereinafter, simply referred to as a last printing job) and presence or absence of the margins for all the combinations of the printing sequence and directions of the images of the printing jobs J1 to J3 are registered. Referring to the first row of FIG. 20, in a case where the image of the printing job J1 is adjacent to the image of the last printing job in the forward direction, the information that the margin is set to the boundary therebetween is registered in the first column, and in a case where the image of the printing job J1 is adjacent to the image of the last printing job in the backward direction, the information that the margin is not set to the boundary therebetween is registered in the second column. The information that the margin is set and the information that the margin is not set are represented by “X” and “O”, respectively. Similarly, the presence or absence of the margins in a case where the image of the printing job J2 is adjacent to the image of the last printing job in the forward direction, a case where the image of the printing job J2 is adjacent to the image of the last printing job in the backward direction, a case where the image of the printing job J3 is adjacent to the image of the last printing job in the forward direction, and a case where the image of the printing job J3 is adjacent to the image of the last printing job in the backward direction is registered in the third, fourth, fifth, and sixth columns, respectively. In the second row and the following rows, the images of the front stage are the image of the printing job J1 in the forward direction, the image of the printing job J1 in the backward direction, the image of the printing job J2 in the forward direction, the image of the printing job J2 in the backward direction, the image of the printing job J3 in the forward direction, and the image of the printing job J3 in the backward direction.

Next, returning to FIG. 18, the process proceeds to Step S108b to generate a job schedule tree representing the printing sequence and directions of the images based on the boundary margin correspondence table 400.

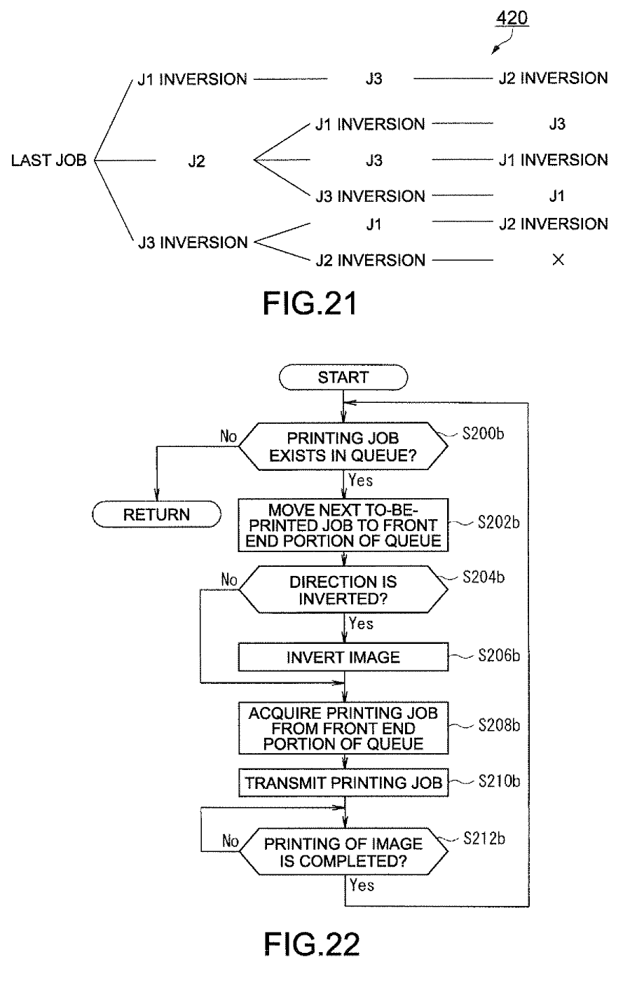

FIG. 21 is a view showing a logic structure of the job schedule tree 420.

As shown in FIG. 21, the job schedule tree 420 is constructed by forming the printing sequence and directions of the images in a form of tree. Referring to the boundary margin correspondence table 400 of FIG. 20, in a case where the image of the last printing job, the image of the printing job J1 in the backward direction, the image of the printing job J3 in the forward direction, and the image of the printing job J2 in the backward are adjacent to each other in this sequence, it can be seen that the margins are not generated at the boundaries therebetween. The uppermost path of the job schedule tree 420 represents the printing sequence and directions of the images which can be continuously printed in the one-cut scheme. Similarly, since there are only four patterns of the printing sequence and directions of the images which can be continuously printed in the one-cut scheme, the paths corresponding to the patterns are formed in the job schedule tree 420.

Next, returning to FIG. 18, the process proceeds to Step S110b to determine the printing sequence and directions of the images which can be continuously printed in the one-cut scheme in a job schedule tree 420 generated according to arbitrary or other conditions. And a series of processes end, and the process returns to the initial process.

Next, the printing job scheduling process is described.

FIG. 22 is a flowchart showing the printing job scheduling process.

As shown in FIG. 22, when executed in the CPU 30b, the printing job scheduling process firstly proceeds to Step S200b.

In Step S200b, it is determined whether or not a printing job exists in the printing job queue 10b. If the printing job is determined to exist (Yes), the process proceeds to the Step S202b to move the printing job of the to-be-printed image next to the last printed image to the front end portion of the printing job queue 10b based on the sequence determined in Step 110b, and the process proceeds to the Step S204b.

In Step S204b, it is determined based on the direction determined in Step S110b whether or not to invert the direction of the next to-be-printed image. If the direction is determined to be inverted (Yes), the process proceeds to Step S206b to invert the direction of the next to-be-printed image, and the process proceeds to Step S208b.

In Step S208b, the printing job is acquired from the front end portion of the printing job queue 10b, and the process proceeds to Step S210b to transmit the acquired printing job to the printing apparatus 200b. And the process proceeds to Step S212b.

In Step S221b, it is determined whether or not printing of one sheet of image is completed according to communication to the printing apparatus 200b. If the printing of the one sheet of image is determined to be completed (Yes), the process proceeds to Step S200b. If not (No), standby is maintained in Step 212b until the printing of the one sheet of image is completed.

On the other hand, in Step S204b, if the direction of the next to-be-printed image is not determined to be inverted (No), the process proceeds to Step S208b.

In Step S200b, if the printing job is not determined to exist in the printing job queue 10b (No), a series of processes end, and the process returns to the initial process.

Next, operations of the embodiment are described.

In the host terminal 100b, when the printing request is input, in Steps S102b and S104b, the printing job is acquired, and the acquired printing job is registered in the rear end portion of the printing job queue 10b. Next, in Steps S106b and S108b, the boundary margin correspondence table 400 where presence or absence of the margins for the boundaries is registered is generated, and the job schedule tree 420 representing the printing sequence and directions of the images is generated based on the boundary margin correspondence table 400. Next, in Step S110b, the printing sequence and directions of the images which can be continuously printed in the one-cut scheme are determined in the job schedule tree 420.

In the host terminal 100b, when the printing job is registered, in Steps S202b to S206, the printing job of the to-be-printed image next to the last printed image is moved to the front end portion of the printing job queue 10b based on the determined sequence and direction, and the direction of the image of the printing job is inverted. For example, in a case where the uppermost path is determined as the printing sequence and direction of the image in the job schedule tree 420 of FIG. 21, the printing job J1 is moved to the front end portion of the printing job queue 10b, and the direction of the image of the printing job J1 is inverted. Next, in Steps S208b and S210b, the printing job is acquired from the front end portion of the printing job queue 10b, and the printing job is transmitted to the printing apparatus 200b.

In the printing apparatus 200b, when the printing job is received, the printing controller 22b controls the printing mechanism 21b based on the received printing job. In addition, the cutting controller 24b controls the cutting mechanism 23b based on the received printing job. As a result, the image of the printing job is printed on the roll paper, and the rear end portion of the image of the printing job is cut.

In this manner, in the embodiment, the printing job including the image data constituting the image and the margin setting information representing whether or not to set margins at two boundaries between adjacent images is acquired, the acquired printing job is registered in the rear end portion of the printing job queue 10b, the registration sequence of the printing job and the direction of the images in the printing job queue 10b are determined based on the margin setting information included in the acquired printing job so as for the images where the margin is not set to the boundary to be adjacent to each other to share the boundary, the printing job is acquired from the front end portion of the printing job queue 10b, and the acquired printing job is transmitted to the printing apparatus 200b.

Therefore, in a case where the image having a margin and the image having no margin are mixed and continuously printed, a probability that the images are adjacent to each other is lowered, so that a margin is not generated at the boundary of the image having no margin, and discarded paper can be reduced. In addition, the printing control can be performed independently of the cutting control, so that a size of the printing apparatus 200b can be reduced.

In addition, in the embodiment, the printing sequence and directions of the images which can be continuously printed in the one-cut scheme are determined among the combinations of the printing sequence of a plurality of the images and directions of the images, the printing job of the to-be-printed image next to the last printed image among the printing jobs in the printing job queue 10b is moved to the front end portion of the printing job queue 10b based on the determined sequence and direction, and the direction of the next to-be-printed image is inverted.

As a result, a probability that the images having no margin and the images having a margin are adjacent to each other is securely lowered, so that the discarded paper can be further reduced.

### OTHER MODIFICATIONS

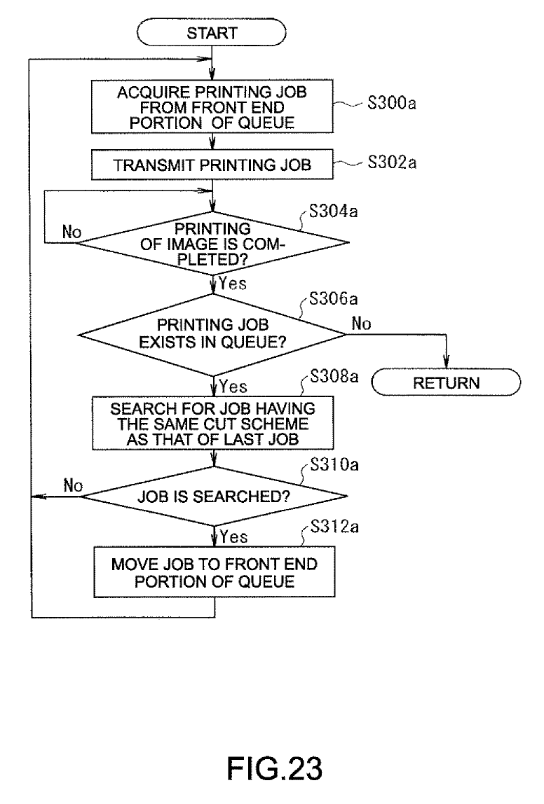

Although the printing job scheduling process shown in the flowchart of FIG. 14 is performed in the third embodiment, the printing job scheduling process shown in the flowchart of FIG. 23 may be performed. The difference from the process of FIG. 14 where the scanning is sequentially performed from the front end portion of the printing job queue 10a is that all the printing jobs of the printing job queue 10a are collectively searched.

FIG. 23 is a flowchart showing the printing job scheduling process.

As shown in FIG. 23, when executed in the CUP 30a, the printing job scheduling process firstly proceeds to Step S300a.

In Step S300a, the printing job is acquired from the front end portion of the printing job queue 10a, and the process proceeds to Step S302a to transmit the acquired printing job to the printing apparatus 200a. And the process proceeds to Step S304a.

In Step 304a, it is determined whether or not printing of one sheet of image is completed according to communication to the printing apparatus 200a. If the printing of the one sheet of image is determined to be completed (Yes), the process proceeds to Step S306a. If not (No), standby is maintained in Step S304a until the printing of the one sheet of image is completed.

In Step S306a, it is determined whether or not a printing job exists in the printing job queue 10a. If the printing job is determined to exist (Yes), the process proceeds to the Step S308a to search for the printing job having the same cut scheme as that of the last printing job in the printing job queue 10a, and the process proceeds to Step S310a.

In the Step 310a, it is determined whether or not the associated printing job is searched. If the printing job is determined to be searched (Yes), the process proceeds to Step S312a to move the searched printing job to the front end portion of the printing job queue 10a, and the process proceeds to Step S300a.

On the other hand, in Step S310a, if the printing job is determined to be searched (No), the process proceeds to Step S300a.

In addition, in the third embodiment, the printing apparatus 200a including the printing mechanism 21a and the cutting mechanism 23a are used, but not limited thereto. A printing apparatus 210a including only the printing mechanism 21a or a printing apparatus 220a including only the cutting mechanism 23a may be used.

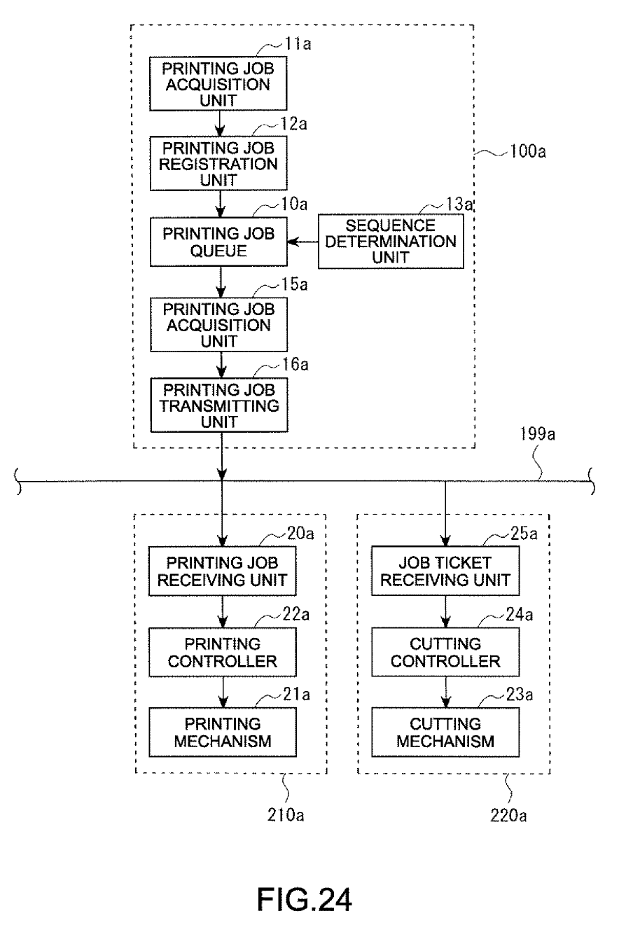

FIG. 24 is a block diagram showing a construction of the network system where the invention is employed.

As shown in FIG. 24, in a network 199a, a host terminal 100a and printing apparatuses 210a and 220a are connected.

The host terminal 10a includes a printing job queue 10a, a printing job acquisition unit 11a, a printing job registration unit 12a, a sequence determination unit 13a, a printing job acquisition unit 15a, and a printing job transmitting unit 16a.

The printing job transmitting unit 16a transmits the printing job acquired by the printing job acquisition unit 15a to the printing apparatus 210a, generates a job ticket based or margin setting information included in the printing job, and transmits the generated job ticket to the printing apparatus 220a.

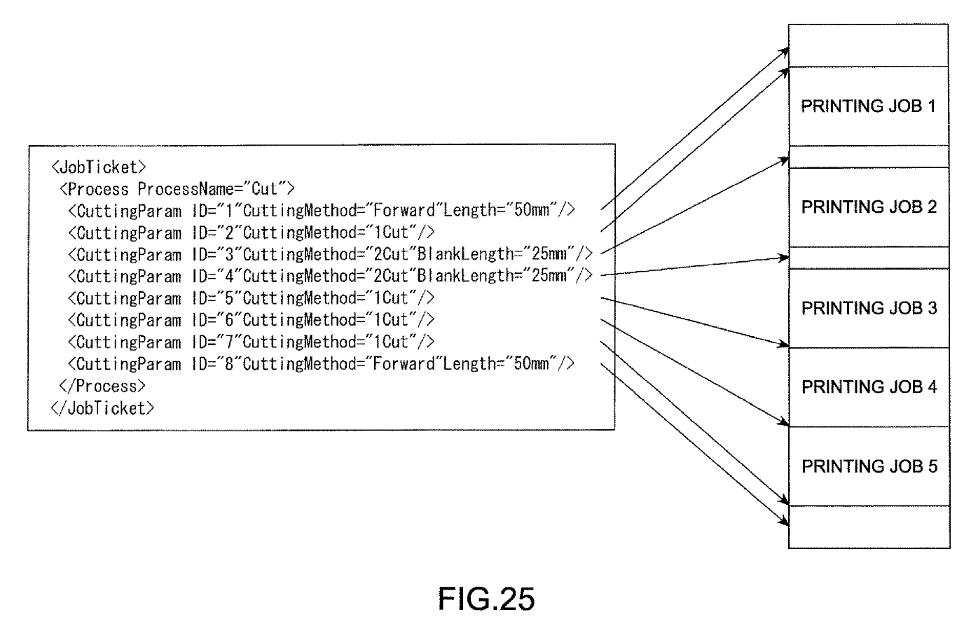

FIG. 25 is a view showing a data structure of the job ticket.

As shown in FIG. 25, the cut schemes and margin lengths of the printing jobs are described in the job ticket. For example, the job ticket may be described in a markup language such as XML (eXtensible Markup Language).

The printing apparatus 210a includes a printing job receiving unit 20a, a printing mechanism 21a, and a printing controller 22a.

The printing apparatus 220a includes a job ticket receiving unit 25a which receives the job ticket, a cutting mechanism 23a, and a cutting controller 24a which controls the cutting mechanism 23a based on the printing job received by the printing job receiving unit 25a.

In addition, in the third embodiment, the process shown in the flowcharts of FIGS. 13, 14, and 23 are performed in the host terminal 100a, but not limited thereto. The process may be performed in the printing apparatus 200a.

In addition, in the fourth embodiment, a case where the margin setting information is included in the printing job is described, but not limited thereto. The invention may be employed in a case where the margin setting information is not included in the printing job. In this case, it is determined based on the image data of the adjacent images whether or not the margin is set. Hereinafter, an example of a determination process of determining whether or not the margin is set is described. The margin determination process is performed in Step S106b.

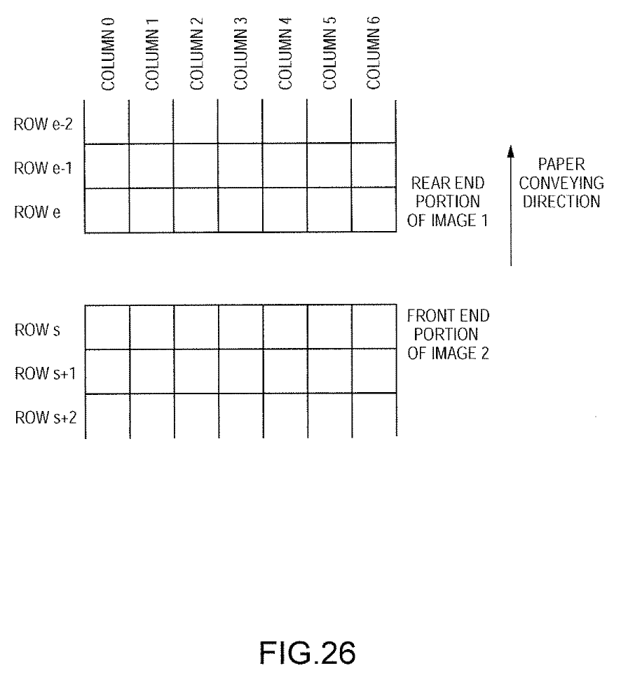

FIG. 26 is a schematic view showing dot data for adjacent two images.

In FIG. 26, squares denote dots, and rows and columns denotes alignment of the dots. Here, positions of the dots are denoted by (row, column). For example, a dot positioned at row e and column 0 is denoted by (e, 0). In FIG. 26, the arrow denotes the paper conveying direction. If a printing head is a printing head for printing line by line, the printing head performs printing in the sequence of row e−2, row e−1, row e, row s, row s+1, and row s+2. In addition, colors of the dots are denoted by c(row, column).

In the example of FIG. 26, the cutting position is between the row e and the row s. When the cutting position and the position of the cutting mechanism 23b are aligned with each other by the paper conveying, the cutting controller 24b allows the cutting mechanism 23b to operate to cut the paper. However, due to a mechanical error, there is an error of the cutting position, and an error range is denoted by I. The error range I is predetermined according to a design tolerance of the mechanism or a pervious test. Here, the dimension of the error range I is defined as a “dot (dot number in the paper conveying direction)”. In addition, the separate error ranges I may be allocated to the front direction (a case where there is a deviation in the rear end direction of the image 1) and the rear direction (a case where there is a deviation in the front end direction of the image 2). For example, the front and rear direction error ranges may be defined as l₁ and l₂. In addition, when the cutting position is deviated, an allowable value (color difference) of a difference between a color of a dot of an image end portion and a color of a dot of another image is denoted by th_{c}. Namely, even though the colors are not accurately equal to each other, a color difference in the case of occurrence of the image mixing does not cause unpleasant feeling, the mixing is set to be allowable, and the allowable error is predetermined.

In this manner, in only the paper conveying direction where the cutting position error may occur, the colors between the dot of the mage end portion and the dot of the facing image which may be mixed are compared, and when the color difference exceeds an allowable difference, the two-cut is selected.

When the color difference of the dot which may be mixed exceeds the allowable value at any one position, the two-cut scheme is selected. However, the following modifications may be considered.

(1) The number of the dots where the color difference exceeds the allowable value is counted, and when the number of dots exceeds a predetermined value, the two-cut scheme may be selected.

(2) When a density of dots where the color difference exceeds the allowable value is equal to or more than a predetermined density, the two-cut may be selected (an abnormal color of one dot is unnoticeable, but a group of the abnormal colors is noticeable).

(3) In the calculation of the color difference, a magnitude of a probability that the cutting position error occurs may be multiplied. Namely, as a position is departed from an ideal cutting position, the probability of the mixing lowers. The probability value is defined according to the distance from the cutting position, and a weight factor may be allocated to the calculation of the color difference.

In this manner, an allowable range is prepared by using the number of dots, the dot density, and the probability in a case where the abnormal color is mixed, the unnoticeable mixing can be neglected, so that the one-cut can be performed. Namely, the process of preventing the waste of paper can be performed more times.

In a case where the dot data are R, G, and B or C, M, Y, and K, in the calculation of the color difference, a sum of the difference of the values corresponding to the compared dot data may be required. More specifically, the color difference may be obtained by calculating color values in an absolute color space such as CIE Lab color specification system based on R, G, and B or C, M, Y, and K of the dot data and converting the color values to ΔE value or other values corresponding to visual differences.

In these constructions, it is possible to obtain the same advantages as those of the fourth embodiment.

In addition, in the fourth embodiment, the printing sequences and directions of the images which can be continuously printed in the one-cut scheme are determined in the job schedule tree 420. However, as shown in FIG. 21, in a case where there are a plurality of candidates of the printing sequences and directions of the images which can be continuously printed in the one-cut scheme, the determination may be performed by using the following methods.

(1) Among the candidates of the printing sequences and directions of the images which can be continuously printed in the one-cut scheme, the printing sequence and direction where there are the lowest number of the images in the backward direction are determined.

When the printing sequences and directions of the images are changed, a user may be confused, or an exchanging task may be required after the printing. Since the printing is performed by using the printing sequence and direction where there is the lowest number of the image in the backward direction, it is possible to reduce the confusion of the user or a burden to the exchanging task after the printing.

(2) Among the candidates of the printing sequences and directions of the images which can be continuously printed in the one-cut scheme, the printing sequence and direction where there are the lowest number of the images in the backward direction or the forward direction are determined.

In a case where there are a large number of the image in the backward direction, an exchanging task for the images in the forward direction may be performed. Therefore, in terms of reducing the task, the printing performed by using the printing sequence and direction where there is the lowest number of the images in the forward direction is equivalent to the printing performed by using the printing sequence and direction where there is the lowest number of the images in the backward direction. In comparison with the method of (1) for example, in a case where, for candidates having the lowest number of the image in the backward direction, the lowest number is 3 and for candidates having the lowest number of the image in the forward direction, the lowest number is 2, the method of (1) determines three candidates, and the method of (2) determines two candidates. Since the exchanging task of the latter is smaller than that of the former, the method of (2) is more effective.

In addition, in the methods of (1) and (2), the determination is made among the candidates of the printing sequences and directions of the images which can be continuously printed in the one-cut scheme, but not limited thereto. Alternatively, the determination may be made among all the candidates of the printing sequences and directions of the images.

In addition, the determination may be performed by using the following methods.

(3) In a case where the printing sequence of the images is important, it is preferable that the sequence is not changed if possible. For the reason, for example, a method of evaluating the change of the printing sequence and, after that, performing the determination may be considered. As an example of the method of evaluating the change of the printing sequence, a method of quantifying the change of the printing sequence may be considered. For example, in a case where the printing sequence of the images of the printing jobs J1, J2, and J3 is changed into the printing sequence of the printing jobs J3, J1, and J2, the printing order of the printing job J1 is changed from 1 to 2, so that the change is quantified as “1”, the printing order of the printing job J2 is changed from 2 to 3, so that the change is quantified as “1”, and the printing order of the printing job J3 is changed from 3 to 1, so that the change is quantified as “2”. The sum of the change is 4, which is defined as the change amount of the printing sequence. Similarly, the change amounts of the printing sequences for other candidates are calculated, and the printing sequence having the smallest change amount is determined.

(4) In a case where a plurality of users use a single printing apparatus 200b, if the printing sequence of the printing jobs among a plurality of the users is changed, a burn to sort the output printing products according to the users may occur. For the reason, the change of the printing sequence may be performed for the continuous printing jobs indicated by the same user (namely, the change is limited to the continuous printing jobs of the same user).

(5) As setting items or attribute values of the printing apparatus 200b or the printing job, (for example, for the aforementioned items), “paper saving” a, “image inversion: available or not available”, “availability of change of printing sequence”, and “change of printing sequence among a plurality of users: available or not available” may be set, and the printing sequence and direction of the images may be determined according to the setting.

In addition, in the fourth embodiment, the printing sequences and directions of the images which can be continuously printed in the one-cut scheme is determined in the job schedule tree 420, but not limited thereto. The printing sequence and direction where there are the largest number of the images (that is, the lowest cut number) where the margin is not set to the boundary and which are adjacent to each other to share the boundary may be determined.

In addition, in the fourth embodiment, the printing apparatus 200b including the printing mechanism 21b and the cutting mechanism 23b are used, but not limited thereto. A printing apparatus 210b including only the printing mechanism 21b or a printing apparatus 220b including only the cutting mechanism 23b may be used.

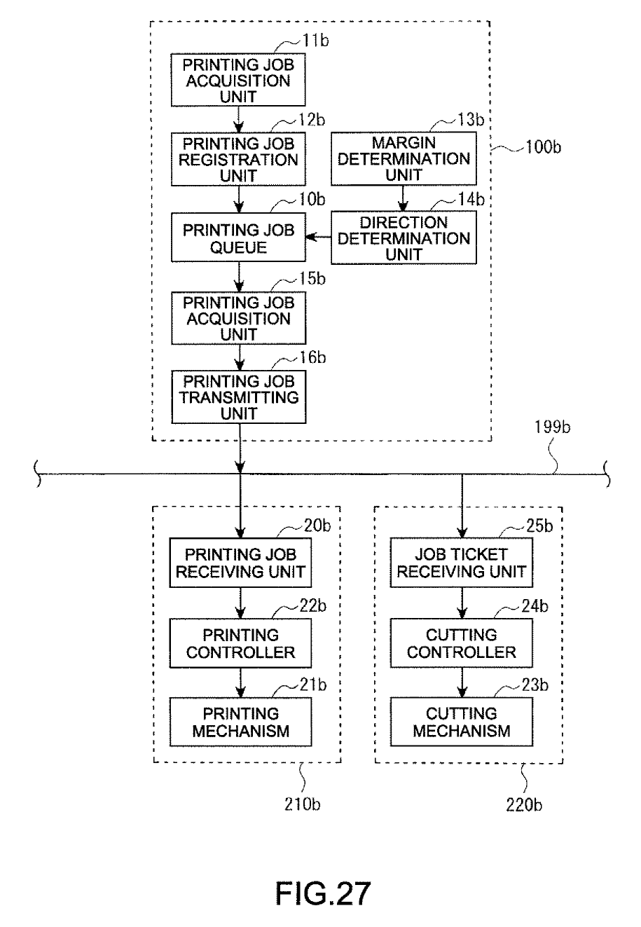

FIG. 27 is a block diagram showing a construction of the network system where the invention is employed.

As shown in FIG. 27, in a network 199b, a host terminal 100b and printing apparatuses 210b and 220b are connected.

The host terminal 100b includes a printing job queue 10b, a printing job acquisition unit 11b, a printing job registration unit 12b, a margin determination unit 13b, a direction determination unit 14b, a printing job acquisition unit 15b, and a printing job transmitting unit 16b.

The printing job transmitting unit 16b transmits the printing job acquired by the printing job acquisition unit 15b to the printing apparatus 210b, generates a job ticket based on margin setting information included in the printing job, and transmits the generated job ticket to the printing apparatus 220b.

The printing apparatus 210b includes a printing job receiving unit 20b, a printing mechanism 21b, and a printing controller 22b.

The printing apparatus 220b includes a job ticket receiving unit 25b which receives the job ticket, a cutting mechanism 23b, and a cutting controller 24b which controls the cutting mechanism 23b based on the printing job received by the printing job receiving unit 25b.

In addition, in the fourth embodiment, the process shown in the flowcharts of FIGS. 18 and 22 are performed in the host terminal 100b, but not limited thereto. The process may be performed in the printing apparatus 200b.

In addition, in the first, third, and fourth embodiments, the processes shown in the flowcharts of FIGS. 7, 13, 14, 18, 22, and 23 are performed by executing the control programs which stores in ROMs 52, 32a, and 32b in advance, but not limited thereto. The programs representing the procedure are stored in storage media, and the programs may be read out into the RAMs 53, 34a, and 34b to be executed.

Here, the storage media include all the storage media including semiconductor storage media such as RAM and ROM, magnetic storage media such as FD and HD, optical readable storage media such as CD, CDV, LD, and DVD, magnetic storage/optical readable media such as MO, and other computer readable storage media irrespective of the reading methods such as electronic, magnetic, and optical methods.

Hereinbefore, the embodiments of the invention are described, but the invention is not limited thereto. Various modifications may be made without departing from the scope and sprit of the invention.

The entire disclosure of Japanese Patent Application Nos:2005-202847, filed Jul. 12, 2005 and 2006-109879, filed Apr. 12, 2006 are expressly incorporated by reference herein.

What is claimed is:

1. A printing system comprising:
a printing unit printing a plurality of images on a printing medium so as for a plurality of the images to be continuously aligned;
a cutting unit setting a boundary between the images or the printing medium where a plurality of the images are printed by the printing unit as a cutting position and performing a first cutting process of cutting the printing medium with a onetime cutting operation or a second cutting process of cutting the printing medium with a two-times cutting operation;
an image comparison unit which compares image data corresponding to adjacent two images in units of two images among a plurality of the images which are continuously printed on the printing medium and determines whether or not a visual effect that feature amounts of the two printed images are in a state of satisfying a predetermined condition occurs;
a printing process selection unit which, based on a determination result of the image comparison unit, selects a first printing process of printing the two images in an adjacent manner with respect to the two images in which the visual effect is not determined to occur and selects a second printing process of preparing a cutting region between the two images and printing the two images with respect to the two images in which the visual effect is determined to occur;
a cutting indicating data generation unit which, for each cutting position of the printing medium based on a selection result of the printing process selection unit, generates cutting indicating data of indicating a cutting process procedure of the cutting unit formed by corresponding the first cutting process to a cutting position corresponding to the first printing process and corresponding the second cutting process to a cutting position corresponding to the second printing process;
a printing data generation unit which generates printing data based on image data corresponding to a plurality of the images and the selection result of the printing process selection unit,
wherein the printing unit selects either one of the first and second printing processes for the image data corresponding to a plurality of the images based on the printing data and performs the printing process, and
wherein the cutting unit selects either one of the first and second cutting processes based on the cutting indicating data and cuts the printing medium.

2. The printing system according to claim 1, wherein the image comparison unit calculates, based on the image data corresponding to the one of the two adjacent images and the image data corresponding to the other of the two adjacent images, a color difference between the two images and determines based on the calculated color difference whether or not the visual effect occurs.

3. The printing system according to claim 2,
wherein the image data are bitmap image data, and
wherein image comparison unit calculates, based on the image data corresponding to the one of the two adjacent images and the image data corresponding to the other of the two adjacent images, a color difference between regions between the two images, counts the number of dots corresponding to the color difference in a case where the color difference exceeds an allowable value of a predetermined color difference, and determines that the visual effect occurs in a case where the count value exceeds a predetermined allowable count value.

4. The printing system according to claim 2,
wherein the image data are bitmap image data,
wherein image comparison unit calculates, based on the image data corresponding to the one of the two adjacent images and the image data corresponding to the other of the two adjacent images, a color difference between regions between the two images, counts the number of dots corresponding to a case where the color difference exceeds an allowable value of a predetermined color difference for predetermined regions of the two images, and determines that the visual effect occurs in a case where the count value of the predetermined region exceeds a predetermined allowable count value.

5. The printing system according to claim 3, wherein the calculation of the color difference is performed by using at least one of a probability that an error of a cutting position by the cutting unit occurs and a distance between the cutting position by the cutting unit and the dot.

6. The printing system according to claim 1, further comprising a cutting indicating data printing unit which codes the cutting indicating data and prints the cutting indicating data on the printing medium,
wherein the cutting unit reads the printed cutting indicating data and selects either one of the first and second processes based on the read cutting indicating data to cut the printing medium.

7. A printing apparatus having a printing unit printing a plurality of images on a printing medium so as for a plurality of the images to be continuously aligned, the printing apparatus comprising:
an image comparison unit which compares image data corresponding to adjacent two images in units of two images among a plurality of the images which are continuously printed on the printing medium and determines whether or not a visual effect that feature amounts of the two printed images are in a state of satisfying a predetermined condition occurs;
a printing process selection unit which, based on a determination result of the image comparison unit, selects a first printing process of printing the two images in an adjacent manner with respect to the two images in which the visual effect is not determined to occur and selects a second printing process of preparing a cutting region between the two images and printing the two images with respect to the two images in which the visual effect is determined to occur;
a cutting indicating data generation unit which, for each cutting position of the printing medium based on a selection result of the printing process selection unit, generates cutting indicating data of indicating a cutting process procedure of the cutting unit formed by corresponding a first cutting process of cutting the printing medium with one-time cutting operation to a cutting position corresponding to the first printing process and corresponding a second cutting process of cutting the printing medium with two-times cutting operation to a cutting position corresponding to the second printing process; and
a printing data generation unit which generates printing data based on image data corresponding to a plurality of the images and the selection result of the printing process selection unit,
wherein the printing unit selects either one of the first and second printing processes for the image data corresponding to a plurality of the images based on the printing data and performs the printing process.

8. A printing program having a process executed by a computer, the process comprising:
printing a plurality of images on a printing medium so as for a plurality of the images to be continuously printed;
cutting the printing medium by setting a boundary between the images on the printing medium where a plurality of the images are printed as a cutting position and performing a first cutting process of cutting the printing medium with a one-time cutting operation or a second cutting process of cutting the printing medium with a two-times cutting operation, the printing system comprising:
comparing image data corresponding to adjacent two images in units of two images among a plurality of the images which are continuously printed on the printing medium and determining whether or not a visual effect that feature amounts of the two printed images are in a state of satisfying a predetermined condition occurs;
selecting a printing process, based on a determination result of the image comparison, to select a first printing process of printing the two images in an adjacent manner with respect to the two images in which the visual effect is not determined to occur and to select a second printing process of preparing a cutting region between the two images and printing the two images with respect to the two images in which the visual effect is determined to occur;
for each cutting position of the printing medium based on a selection result of the printing process selection, generating cutting indicating data of indicating a cutting process procedure of the cutting formed by corresponding the first cutting process to a cutting position corresponding to the first printing process and corresponding the second cutting process to a cutting position corresponding to the second printing process;
generating printing data based on image data corresponding to a plurality of the images and the selection result of the printing process selection.
